(19) United States
(12) Patent Application Publication
(10) Pub. No.: US 2015/0014283 A1
(43) Pub. Date: Jan. 15, 2015

(54) Hybrid Hot-Wire And Arc Welding Method And System Using Offset Positioning

(71) Applicant: LINCOLN GLOBAL, INC., City of Industry, CA (US)

(72) Inventors: Steven R. Peters, Huntsburg, OH (US); William T. Matthews, Chesterland, OH (US); Kent Johns, Hudson, OH (US)

(21) Appl. No.: 14/504,807

(22) Filed: Oct. 2, 2014

Related U.S. Application Data
(63) Continuation-in-part of application No. 13/547,649, filed on Jul. 12, 2012.
Application No. 13/547,649 is a continuation-in-part of application No. 13/212,025, filed on Aug. 17, 2011.
Application No. 13/212,025 is a continuation-in-part of application No. 12/352,667, filed on Jan. 13, 2009, now Pat. No. 8,653,417.
(60) Provisional application No. 61/942,887, filed on Feb. 21, 2014.
(60) Provisional application No. 61/943,633, filed on Feb. 24, 2014.

(51) Int. Cl. B23K 9/10; B23K 9/173; B23K 9/095

(52) U.S. Cl. CPC B23K 9/1093; B23K 9/0956; B23K 9/1012; B23K 9/173
USPC 219/74; 219/130.21; 219/137 PS

(57) ABSTRACT

A method and system to weld or join coated workpieces using an arc welding operation and at least one hot wire, resistance heated wire. Each of the arc welding and hot wire operation are directed to the same puddle. However, the arc welding operation is offset out of the joint from the hot wire operation, where the hot wire is directed into the joint.

### INCORPORATION BY REFERENCE

The present application claims priority to and is a continuation in part of U.S. patent application Ser. No. 13/547,649 filed on Jul. 12, 2012 which is a continuation in part of U.S. patent application Ser. No. 13/212,025 filed on Aug. 17, 2011 which is a continuation in part of U.S. patent application Ser. No. 12/352,667, filed on Jan. 13, 2009, now U.S. Pat. No. 8,653,417, all three of which are incorporated herein by reference in their entirety, and claims priority to each of U.S. Provisional Application No. 61/942,887 filed on Feb. 21, 2014 and U.S. Provisional Application No. 61/943,633, filed on Feb. 24, 2014, both of which are incorporated herein by reference in their entirety.

### TECHNICAL FIELD

Certain embodiments relate to welding and joining applications. More particularly, certain embodiments relate to system and methods to for joining and welding applications using hot-wire and arc welding systems in an off-set relationship.

### BACKGROUND

Many welding and joining methods impart a significant amount of heat into a weld joint and can result in a fair amount of penetration into the workpieces being joined. In some applications, such as when joining thin workpieces which have a coating, such as galvanization, this heat and penetration can be detrimental. Specifically, the heat and penetration can vaporize the zinc coating which can result in porosity in the weld joint. Further, workpiece deformation can occur because of the heat input, particularly in thin workpieces. Advancements have been made with some joining techniques, such as when using hybrid laser and hot-wire systems. However, for some applications, the laser can be too costly.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to join workpieces. Specifically embodiments are directed to using systems and methods to join coated workpieces using a GMAW and hot wire system employing an offset between the GMAW and hot-wire processes in the puddle. Further embodiments utilize signal synchronization to control the arc of the GMAW process and the puddle.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A and 1B illustrate functional schematic block diagrams of exemplary embodiments of a system that can be used for joining or welding applications;

FIG. 2 illustrates a flow chart of an embodiment of a start-up method used by the system of FIG. 1;

FIG. 3 illustrates a flow chart of an embodiment of a post start-up method used by the system of FIG. 1;

FIG. 4 illustrates a first exemplary embodiment of a pair of voltage and current waveforms associated with the post start-up method of FIG. 3;

FIG. 5 illustrates a second exemplary embodiment of a pair of voltage and current waveforms associated with the post start-up method of FIG. 3;

FIGS. 6A to 6C illustrate an exemplary welding operation and weld bead;

FIGS. 7A to 7D illustrate exemplary embodiments of hot-wire and welding waveforms to be used with embodiments of the present invention;

FIG. 8 illustrate additional exemplary waveforms that can be used with embodiments of the present invention;

FIG. 9 illustrates an exemplary embodiment of a ramp down circuit which can be used in embodiments of the present invention;

FIG. 10 illustrates a hot wire power supply system in accordance with an embodiment of the present invention;

FIG. 11A to 11C illustrate voltage and current waveforms used by exemplary embodiments of the present invention; and

FIG. 12 illustrates an additional exemplary embodiment of a welding operation of the present invention utilizing magnetic steering.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

The following discussion is directed to joining and welding applications for clarity and simplicity, however it is noted that embodiments of the present invention are not limited in such a way and can be used in other types of applications requiring the deposition of materials from consumables, including but not limited to brazing, cladding, building up, filling, and hard-facing.

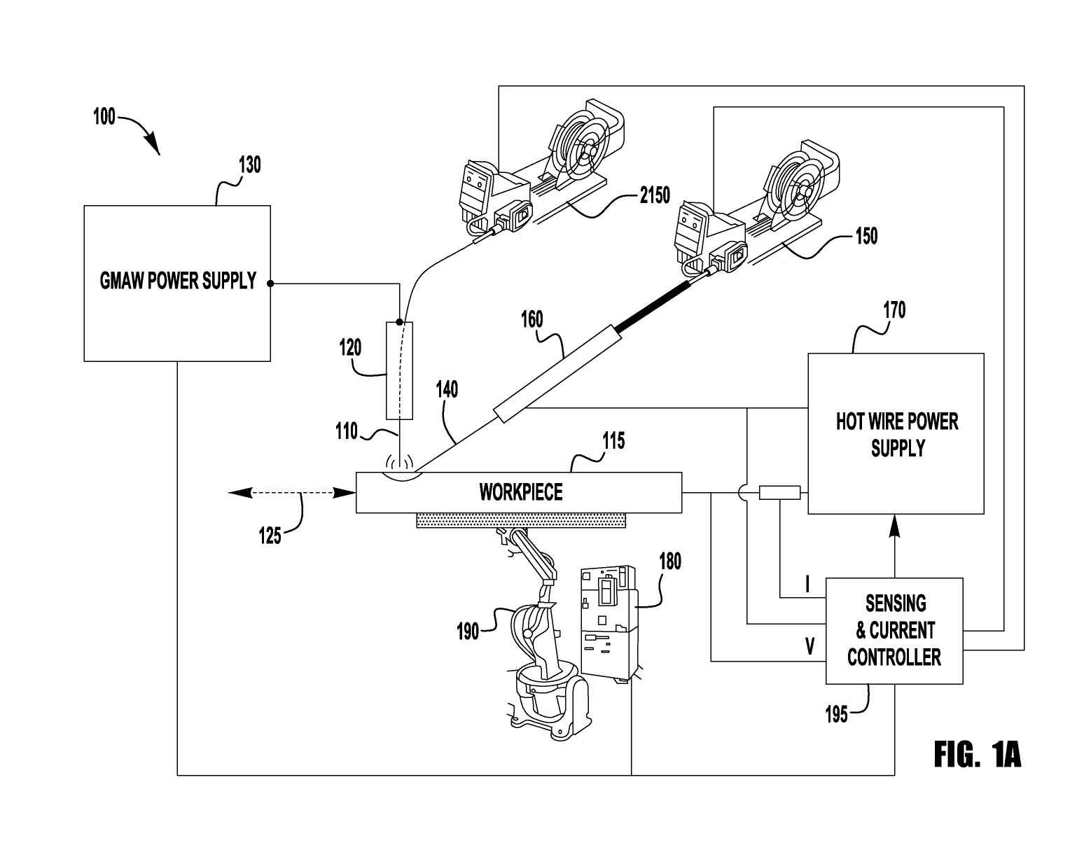

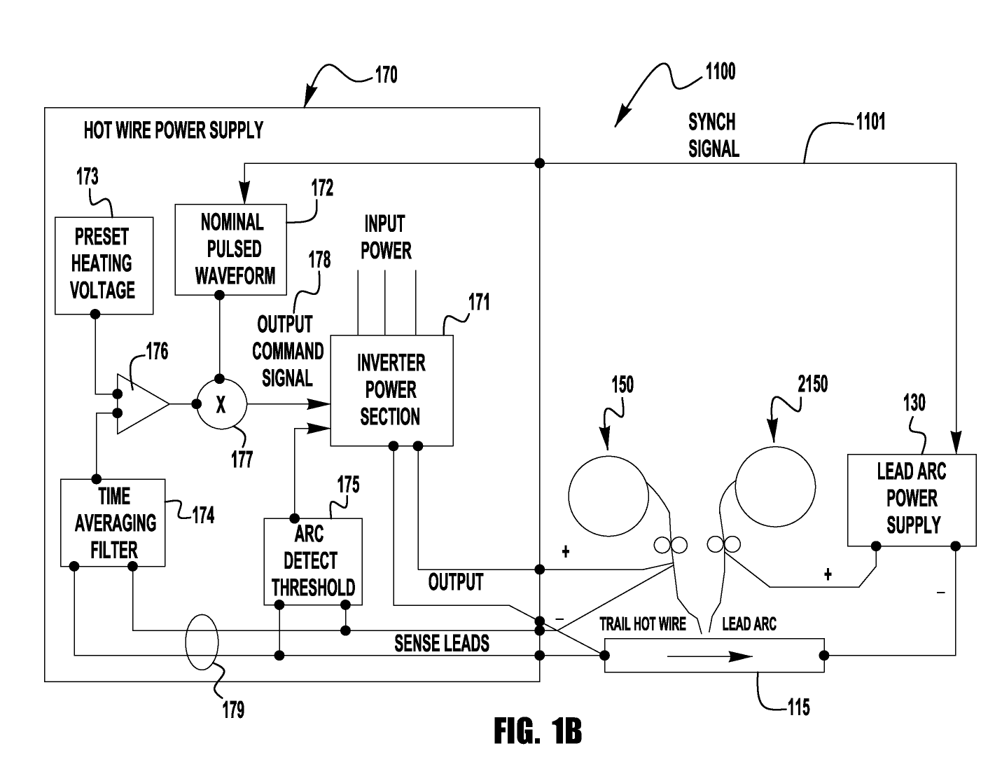

FIG. 1A illustrates a functional schematic block diagram of an exemplary embodiment of a combination filler wire feeder and arc welding system 100 for performing joining and welding applications. The system 100 includes an arc welding system (such as a GMAW or GTAW system) which deposits a consumable 110 onto a workpiece 115 pursuant to an arc welding process. Shown in FIG. 1 is a GMAW type of arc welding system, employing a torch 120. The arc welding subsystem, comprising the power supply 130, torch 120 and wire feeder 2150 can be constructed and operated similar to known arc welding systems and its detailed construction and operation need not be discussed in detail herein.

It should be noted that discussion set forth herein focuses on a system 100 which uses a GMAW type welding system along with the hot wire system (see, e.g., FIG. 1A). However, other exemplary embodiments of the system 100 can use other types of arc welding systems, including GTAW or plasma arc welding (PAW) type systems. In some exemplary embodiments using either a GTAW or PAW type welding system a consumable (such as wire 110) can be used with the GTAW/PAW system in addition to the hot wire consumable 140. Thus, in those systems the deposition of material is similar to that described relative to the GMAW system shown in FIG. 1A. However, in other exemplary embodiments the hot wire 140 is the consumable of the leading GTAW or PAW process. That is, in such systems there is no leading consumable deposited, but instead the leading arc (from either the GTAW or PAW process) is offset as described herein to create the puddle or provide the necessary penetration and the hot wire is the only consumable deposited. In either of the above described embodiments, the operation and control of the system is similar to the control and operation of the GMAW exemplary embodiments described herein.

The system 100 also includes a hot filler wire feeder subsystem capable of providing at least one resistive filler wire 140 to make contact with the workpiece 115 in the vicinity of the consumable 110. Of course, it is understood that by reference to the workpiece 115 herein, the molten puddle is considered part of the workpiece 115, thus reference to contact with the workpiece 115 includes contact with the puddle. The hot filler wire feeder subsystem includes a filler wire feeder 150, a contact tube 160, and a hot wire power supply 170. During operation, the filler wire 140 is resistance-heated by electrical current from the hot wire welding power supply 170 which is operatively connected between the contact tube 160 and the workpiece 115. In accordance with an embodiment of the present invention, the hot wire welding power supply 170 is a pulsed direct current (DC) power supply, although alternating current (AC) or other types of power supplies are possible as well. The wire 140 is fed from the filler wire feeder 150 through the contact tube 160 toward the workpiece 115 and extends beyond the tube 160. The extension portion of the wire 140 is resistance-heated such that the extension portion approaches or reaches the melting point before contacting a weld puddle on the workpiece. The arc welding operation serves to melt some of the base metal of the workpiece 115 to form a weld puddle into which the wire 140 is directed. The power supply 170 provides a large portion of the energy needed to resistance-melt the filler wire 140. The feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece.

The system 100 further includes a motion control subsystem 190/180 capable of moving the arc welding operation (torch 120/consumable 110) and the resistive filler wire 140 in a same direction 125 along the workpiece 115 (at least in a relative sense) such that the consumable 110 and the resistive filler wire 140 remain in a fixed relation to each other. According to various embodiments, the relative motion between the workpiece 115 and the wire combination may be achieved by actually moving the workpiece 115 or by moving the consumable 110/torch 120 and the hot wire feeder subsystem. In FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the consumable 110 and the wire 140 effectively travel along the workpiece 115. In accordance with an alternative embodiment of the present invention, the torch 120 and the contact tube 160 may be integrated into a single head. The head may be moved along the workpiece 115 via a motion control subsystem operatively connected to the head.

In general, there are several methods that a high intensity energy source/hot wire may be moved relative to a workpiece. If the workpiece is round, for example, the high intensity energy source/hot wire may be stationary and the workpiece may be rotated under the high intensity energy source/hot wire. Alternatively, a robot arm or linear tractor may move parallel to the round workpiece and, as the workpiece is rotated, the high intensity energy source/hot wire may move continuously or index once per revolution to, for example, overlay the surface of the round workpiece. If the workpiece is flat or at least not round, the workpiece may be moved under the high intensity energy source/hot wire as shown if FIG. 1. However, a robot arm or linear tractor or even a beam-mounted carriage may be used to move a high intensity energy source/hot wire head relative to the workpiece.

The system 100 further includes a sensing and current control subsystem 195 which is operatively connected to the workpiece 115 and the contact tube 160 (i.e., effectively connected to the output of the hot wire power supply 170) and is capable of measuring a potential difference (i.e., a voltage V) between and a current (I) through the workpiece 115 and the hot wire 140. The sensing and current control subsystem 195 may further be capable of calculating a resistance value (R=V/I) and/or a power value (P=V*I) from the measured voltage and current. In some embodiments, when the hot wire 140 is in contact with the workpiece 115, the potential difference between the hot wire 140 and the workpiece 115 is zero volts or very nearly zero volts. However, in other exemplary embodiments, there can be a voltage drop between the hot wire 140 and the workpiece 115. In exemplary embodiments this voltage drop can be in the range of 2 to 8 volts. As a result, the sensing and current control subsystem 195 is capable of sensing when the resistive filler wire 140 is in contact with the workpiece 115 and is operatively connected to the hot wire power supply 170 to be further capable of controlling the flow of current through the resistive filler wire 140 in response to the sensing, as is described in more detail later herein. In accordance with another embodiment of the present invention, the sensing and current controller 195 may be an integral part of the hot wire power supply 170 and/or the arc welding power supply 130.

In accordance with an embodiment of the present invention, the motion controller 180 may further be operatively connected to the power supply 130 and/or the sensing and current controller 195. In this manner, the motion controller 180 and the power supply 130 may communicate with each other such that the power supply 130 knows when the workpiece 115 is moving. Similarly, in this manner, the motion controller 180 and the sensing and current controller 195 may communicate with each other such that the sensing and current controller 195 knows when the workpiece 115 is moving and such that the motion controller 180 knows if the hot filler wire feeder subsystem is active. Such communications may be used to coordinate activities between the various subsystems of the system 100.

FIG. 1B illustrates a schematic diagram of an exemplary control system 1100 of the system 100 shown in FIG. 1A. It is noted that for purposes of clarity the controller 195 is not shown, but can be utilized as described above. Alternatively, the control can be internal to either one of the arc or hot wire power supplies. As shown, the hot wire power supply 170 is coupled to the arc power supply 130 via a synch signal 1101 which allows the respective power supplies to synchronize their output currents. The advantages and details of this synchronization is discussed further below. Methods and systems of signal synchronization are generally known and need not be described in detail herein. For example, known synchronization techniques that are used for synchronizing tandem arc welding systems can be used.

As shown, exemplary embodiments of the hot wire power supply 170 comprise an inverter power section 171 which received an input power and provides the heating output current to the electrode 140. Of course, other types of power conversion topologies can be used and embodiments of the present invention are not limited to the use of inverter technology. The power section 171 can include components such as rectifiers, boost circuits, buck circuits, power factor correction modules, transformers, etc. so long as the circuit can convert the input power to a desired heating signal output. The power supply 170 also includes a nominal pulse waveform control module 172 which generates a nominal desired heating waveform. For example, this module 172 creates a desired nominal pulse profile, including peak current, peak duration, background current, and frequency, and base the nominal waveform on various input parameters. This module 172 is coupled to the arc power supply 130 via the synch signal 1101 to ensure that the generated current output has the desired synchronization, e.g., that the frequency of the waveform is adjusted appropriately. In exemplary embodiments, the parameters of the waveform can be adjusted to achieve a desired average voltage between the hot wire 140 and the workpiece 115. This preset heating voltage can be generated by a preset heating voltage module 173, which uses various input parameters to generate a set heating voltage for the output heating signal. As stated above, in some exemplary embodiments, the voltage is in a range of 2 to 8 volts. However, in some exemplary embodiments the module 173 can set the desired voltage based on at least one of the wire size, wire type and/or wire feed speed of the operation. In some embodiments with a low wire feed speed the voltage can be in the range of 2 to 4 volts, whereas in other embodiments with a higher wire feed speed the voltage can be set to be in the range of 5 to 8 volts.

The power supply 170 also includes an arc detect threshold module 175 which monitors the actual hot wire voltage and/or current via the sense leads 179. When the module detects voltage spikes between the hot wire 140 and the workpiece 115 this is indicative of the presence of an arc. If an arc/voltage spike is detected the module 175 outputs a signal to the power section 171 to diminish the output or shut off the output signal which will suppress the arc. In exemplary embodiments of the present the arc detection threshold is in the range of 12 to 19 volts. In other exemplary embodiments different voltages or voltage ranges can be used. The power supply 170 also includes a time averaging filter module 174 which also receives the hot wire voltage and/or current from the sense leads 179. The module 174 utilizes the sensed voltage and/or current to output a signal to the comparator 176 which compares this signal with the preset heating voltage output by the module 173. The comparator 176 outputs an error signal to a multiplier 177 which also receives an output from the pulse waveform module 172. By combining these two signals the multiplier 177 outputs a command signal 178 to the power section 171 to control the power section 171 to output a desired waveform. Of course, it is understood that the above control methodology is exemplary and that other control methodologies can be used without departing from the spirit or scope of the present invention.

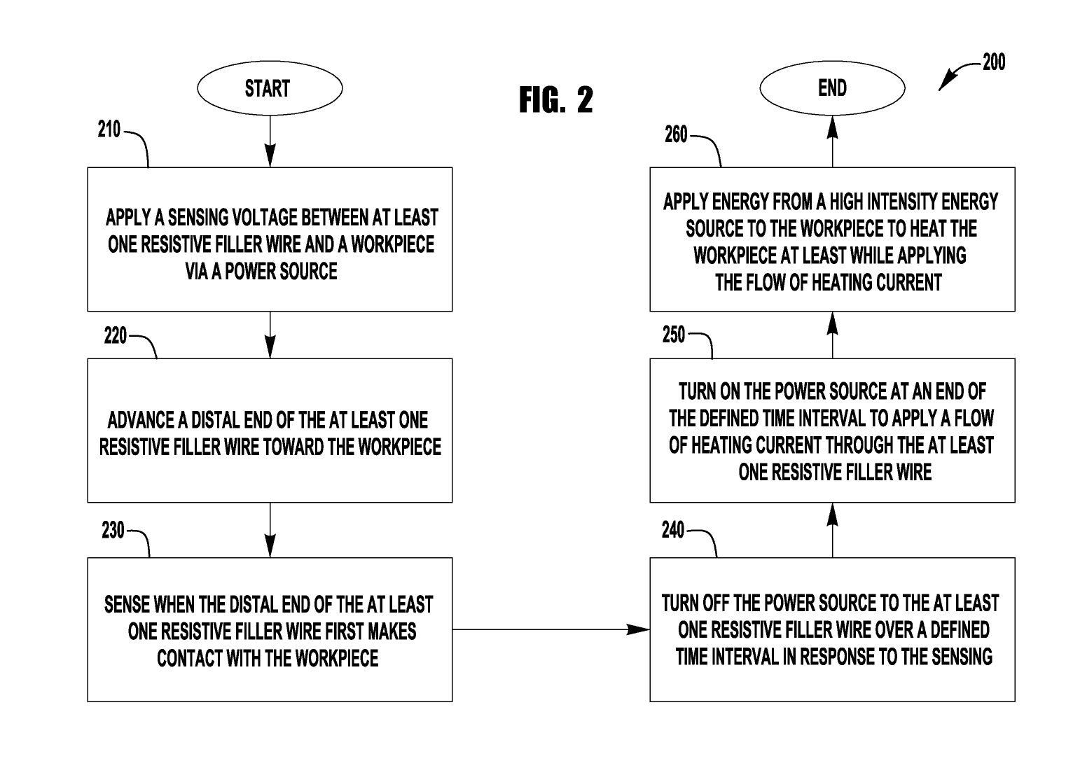

FIG. 2 illustrates a flow chart of an embodiment of a start-up method 200 used by the system 100 of FIG. 1A. In step 210, apply a sensing voltage between at least one resistive filler wire 140 and a workpiece 115 via a power source 170. The sensing voltage may be applied by the hot wire power supply 170 under the command of the sensing and current controller 195. Furthermore, the applied sensing voltage does not provide enough energy to significantly heat the wire 140, in accordance with an embodiment of the present invention. In step 220, advance a distal end of the at least one resistive filler wire 140 toward the workpiece 115. The advancing is performed by the wire feeder 150. In step 230, sense when the distal end of the at least one resistive filler wire 140 first makes contact with the workpiece 115. For example, the sensing and current controller 195 may command the hot wire power supply 170 to provide a very low level of current (e.g., 3 to 5 amps) through the hot wire 140. Such sensing may be accomplished by the sensing and current controller 195 measuring a potential difference of about zero volts (e.g., 0.4V) between the filler wire 140 (e.g., via the contact tube 160) and the workpiece 115. When the distal end of the filler wire 140 is shorted to the workpiece 115 (i.e., makes contact with the workpiece), a significant voltage level (above zero volts) may not exist between the filler wire 140 and the workpiece 115.

In step 240, turn off the power source 170 to the at least one resistive filler wire 140 over a defined time interval (e.g., several milliseconds) in response to the sensing. The sensing and current controller 195 may command the power source 170 to turn off. In step 250, turn on the power source 170 at an end of the defined time interval to apply a flow of heating current through the at least one resistive filler wire 140. The sensing and current controller 195 may command the power source 170 to turn on. In step 260, apply energy from a high intensity energy source (such as an arc welding operation) to the workpiece 115 to heat the workpiece 115 at least while applying the flow of heating current.

As an option, the method 200 may include stopping the advancing of the wire 140 in response to the sensing, restarting the advancing (i.e., re-advancing) of the wire 140 at the end of the defined time interval, and verifying that the distal end of the filler wire 140 is still in contact with the workpiece 115 before applying the flow of heating current. The sensing and current controller 195 may command the wire feeder 150 to stop feeding and command the system 100 to wait (e.g., several milliseconds). In such an embodiment, the sensing and current controller 195 is operatively connected to the wire feeder 150 in order to command the wire feeder 150 to start and stop. The sensing and current controller 195 may command the hot wire power supply 170 to apply the heating current to heat the wire 140 and to again feed the wire 140 toward the workpiece 115.

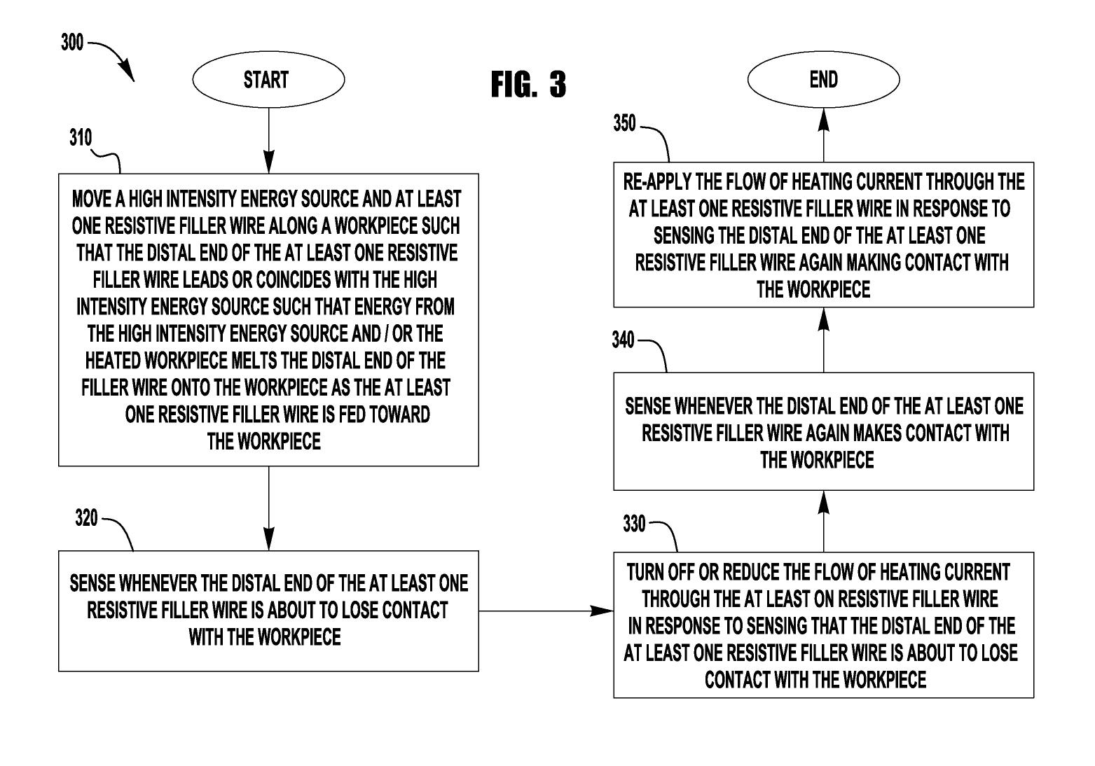

Once the start up method is completed, the system 100 may enter a post start-up mode of operation where the arc welding operation and hot wire 140 are moved in relation to the workpiece 115 to perform a welding/joining operation. FIG. 3 illustrates a flow chart of an embodiment of a post start-up method 300 used by the system 100 of FIG. 1A. In step 310, move the arc welding operation and at least one resistive filler wire 140 along a workpiece 115 such that the distal end of the at least one resistive filler wire 140 melts in the created puddle and is deposited onto the workpiece 115 as the at least one resistive filler wire 140 is fed toward the workpiece 115. The motion controller 180 commands the robot 190 to move the workpiece 115 in relation to the arc welding and the hot wire 140. The power supply 130 provides the power to the arc welding operation. The hot wire power supply 170 provides electric current to the hot wire 140 as commanded by the sensing and current controller 195.

In step 320, sense whenever the distal end of the at least one resistive filler wire 140 is about to lose contact with the workpiece 115 (i.e., provide a premonition capability). Such sensing may be accomplished by a premonition circuit within the sensing and current controller 195 measuring a rate of change of one of a potential difference between (dv/dt), a current through (di/dt), a resistance between (dr/dt), or a power through (dp/dt) the filler wire 140 and the workpiece 115. When the rate of change exceeds a predefined value, the sensing and current controller 195 formally predicts that loss of contact is about to occur. Such premonition circuits are well known in the art for arc welding.

When the distal end of the wire 140 becomes highly molten due to heating, the distal end may begin to pinch off from the wire 140 onto the workpiece 115. For example, at that time, the potential difference or voltage increases because the cross section of the distal end of the wire decreases rapidly as it is pinching off. Therefore, by measuring such a rate of change, the system 100 may anticipate when the distal end is about to pinch off and lose contact with the workpiece 115. Also, if contact is fully lost, a potential difference (i.e., a voltage level) which is significantly greater than zero volts may be measured by the sensing and current controller 195. This potential difference could cause an arc to form (which is undesirable) between the new distal end of the wire 140 and the workpiece 115 if the action in step 330 is not taken. Of course, in other embodiments the wire 140 may not show any appreciable pinching but will rather flow into the puddle in a continuous fashion while maintaining a nearly constant cross-section into the puddle.

In step 330, turn off (or at least greatly reduce, for example, by 95%) the flow of heating current through the at least one resistive filler wire 140 in response to sensing that the distal end of the at least one resistive filler wire 140 is about to lose contact with the workpiece 115. When the sensing and current controller 195 determines that contact is about to be lost, the controller 195 commands the hot wire power supply 170 to shut off (or at least greatly reduce) the current supplied to the hot wire 140. In this way, the formation of an unwanted arc is avoided, preventing any undesired effects such as splatter or burnthrough from occurring.

In step 340, sense whenever the distal end of the at least one resistive filler wire 140 again makes contact with the workpiece 115 due to the wire 140 continuing to advance toward the workpiece 115. Such sensing may be accomplished by the sensing and current controller 195 measuring a potential difference between the filler wire 140 (e.g., via the contact tube 160) and the workpiece 115. When the distal end of the filler wire 140 is shorted to the workpiece 115 (i.e., makes contact with the workpiece), a significant voltage level above zero volts may not exist between the filler wire 140 and the workpiece 115. The phrase “again makes contact” is used herein to refer to the situation where the wire 140 advances toward the workpiece 115 and the measured voltage between the wire 140 (e.g., via the contact tube 160) and the workpiece 115 is within a predetermined contact voltage range (e.g., between 2 and 8 volts), whether or not the distal end of the wire 140 actually fully pinches off from the workpiece 115 or not. In step 350, re-apply the flow of heating current through the at least one resistive filler wire in response to sensing that the distal end of the at least one resistive filler wire again makes contact with the workpiece. The sensing and current controller 195 may command the hot wire power supply 170 to re-apply the heating current to continue to heat the wire 140. This process may continue for the duration of the overlaying application.

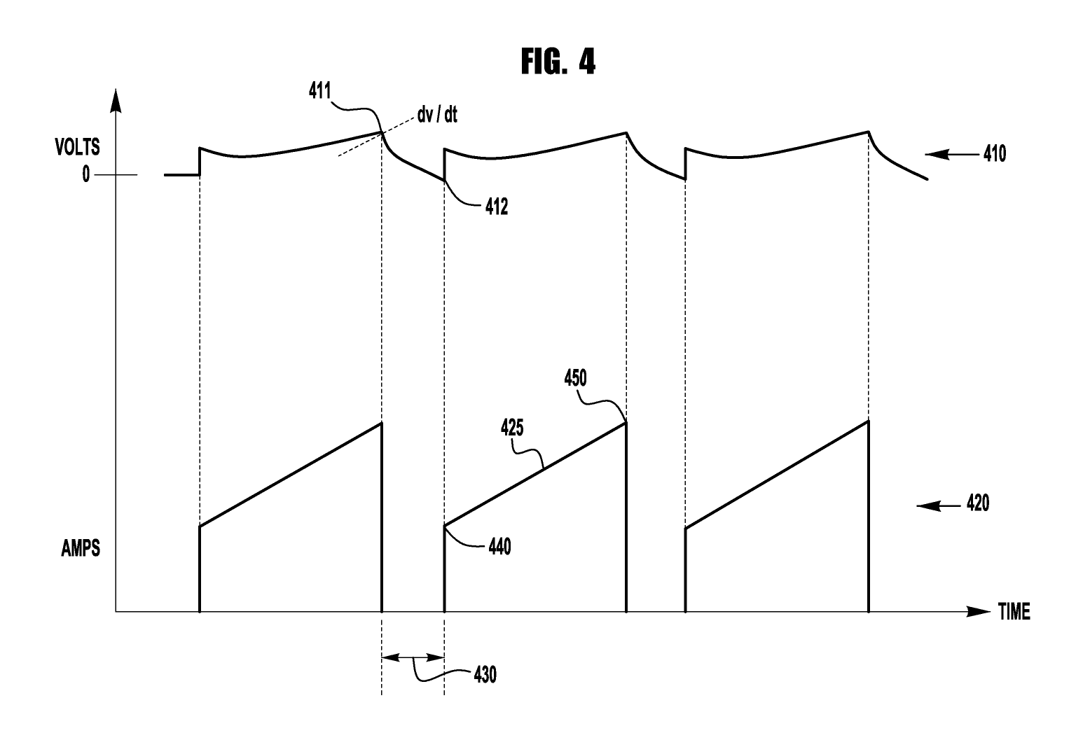

For example, FIG. 4 illustrates a first exemplary embodiment of a pair of voltage and current waveforms 410 and 420, respectively, associated with the post start-up method 300 of FIG. 3. The voltage waveform 410 is measured by the sensing and current controller 195 between the contact tube 160 and the workpiece 115. The current waveform 420 is measured by the sensing and current controller 195 through the wire 140 and workpiece 115.

Whenever the distal end of the resistive filler wire 140 is about to lose contact with the workpiece 115, the rate of change of the voltage waveform 410 (i.e., dv/dt) will exceed a predetermined threshold value, indicating that pinch off is about to occur (see the slope at point 411 of the waveform 410). As alternatives, a rate of change of current through (di/dt), a rate of change of resistance between (dr/dt), or a rate of change of power through (dp/dt) the filler wire 140 and the workpiece 115 may instead be used to indicate that pinch off is about to occur. Such rate of change premonition techniques are well known in the art. At that point in time, the sensing and current controller 195 will command the hot wire power supply 170 to turn off (or at least greatly reduce) the flow of current through the wire 140.

When the sensing and current controller 195 senses that the distal end of the filler wire 140 again makes good contact with the workpiece 115 after some time interval 430 (e.g., the voltage level drops back to a voltage level that indicates contact at point 412), the sensing and current controller 195 commands the hot wire power supply 170 to ramp up the flow of current (see ramp 425) through the resistive filler wire 140 toward a predetermined output current level 450. In accordance with an embodiment of the present invention, the ramping up starts from a set point value 440. This process repeats as the energy source 120 and wire 140 move relative to the workpiece 115 and as the wire 140 advances towards the workpiece 115 due to the wire feeder 150. In this manner, contact between the distal end of the wire 140 and the workpiece 115 is largely maintained and an arc is prevented from forming between the distal end of the wire 140 and the workpiece 115. Ramping of the heating current helps to prevent inadvertently interpreting a rate of change of voltage as a pinch off condition or an arcing condition when no such condition exists. Any large change of current may cause a faulty voltage reading to be taken due to the inductance in the heating circuit. When the current is ramped up gradually, the effect of inductance is reduced.

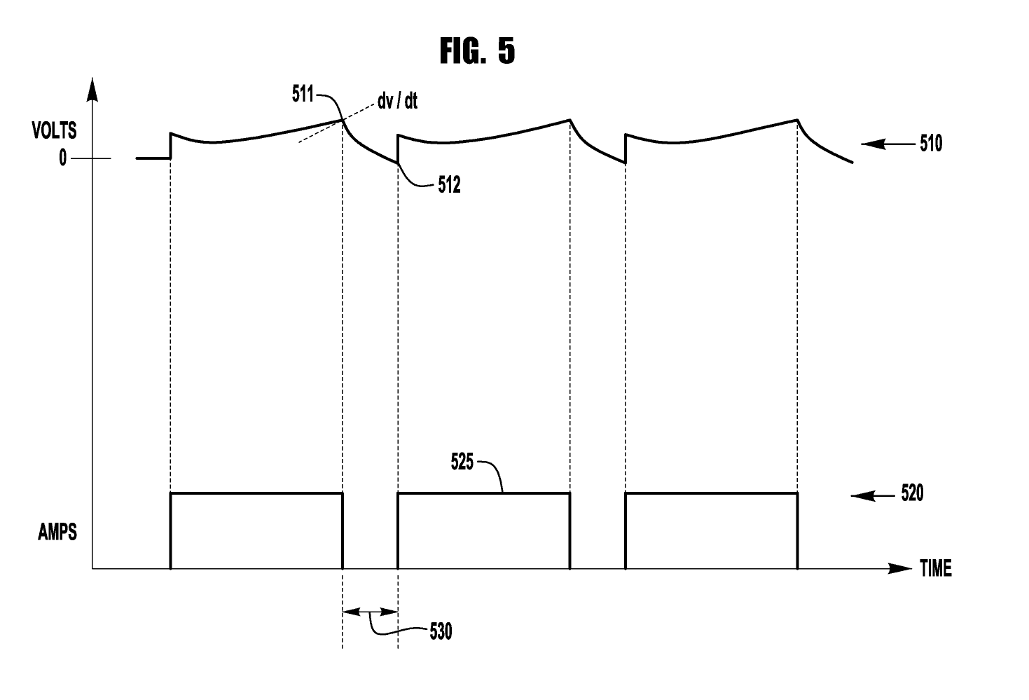

FIG. 5 illustrates a second exemplary embodiment of a pair of voltage and current waveforms 510 and 520, respectively, associated with the post start-up method of FIG. 3. The voltage waveform 510 is measured by the sensing and current controller 195 between the contact tube 160 and the workpiece 115. The current waveform 520 is measured by the sensing and current controller 195 through the wire 140 and workpiece 115.

Whenever the distal end of the resistive filler wire 140 is about to lose contact with the workpiece 115, the rate of change of the voltage waveform 510 (i.e., dv/dt) will exceed a predetermined threshold value, indicating that pinch off is about to occur (see the slope at point 511 of the waveform 510). As alternatives, a rate of change of current through (di/dt), a rate of change of resistance between (dr/dt), or a rate of change of power through (dp/dt) the filler wire 140 and the workpiece 115 may instead be used to indicate that pinch off is about to occur. Such rate of change premonition techniques are well known in the art. At that point in time, the sensing and current controller 195 will command the hot wire power supply 170 to turn off (or at least greatly reduce) the flow of current through the wire 140.

When the sensing and current controller 195 senses that the distal end of the filler wire 140 again makes good contact with the workpiece 115 after some time interval 530 (e.g., the voltage level drops back to a contact level at point 512), the sensing and current controller 195 commands the hot wire power supply 170 to apply the flow of heating current (see heating current level 525) through the resistive filler wire 140. This process repeats as the torch 120 and wire 140 move relative to the workpiece 115 and as the wire 140 advances towards the workpiece 115 due to the wire feeder 150. In this manner, contact between the distal end of the wire 140 and the workpiece 115 is largely maintained and an arc is prevented from forming between the distal end of the wire 140 and the workpiece 115. Since the heating current is not being gradually ramped in this case, certain voltage readings may be ignored as being inadvertent or faulty due to the inductance in the heating circuit.

In summary, a method and system to use an arc welding and hot wire operation in a single molten puddle is disclosed to weld, join or perform other types of deposition operations is disclosed. The arc welding operation provides heat to the workpiece to create a puddle and deposit a consumable on the workpiece. One or more resistive filler wires are fed toward the workpiece near the arc welding operation. Sensing of when a distal end of the one or more resistive filler wires makes contact with the workpiece at or near the applied high intensity energy is accomplished. Electric heating current to the one or more resistive filler wires is controlled based on whether or not the distal end of the one or more resistive filler wires is in contact with the workpiece. The applied high intensity energy and the one or more resistive filler wires are moved in a same direction along the workpiece in a fixed relation to each other.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. Furthermore, there is a need to provide systems which can weld quickly under adverse environmental conditions, such as in remote work sites. As described below, exemplary embodiments of the present invention provide significant advantages over existing welding technologies. Such advantages include, but are not limited to, reduced total heat input resulting in low distortion of the workpiece, very high welding travel speeds, very low spatter rates, welding plated or coated materials at high speeds with little or no spatter and welding complex materials at high speeds.

In exemplary embodiments of the present invention, very high welding speeds, as compared to arc welding, can be obtained using coated workpieces, which typically require significant prep work and are much slower welding processes using arc welding methods. As an example, the following discussion will focus on welding galvanized workpieces. Galvanization of metal is used in increase the corrosion resistance of the metal and is desirable in many industrial applications. However, conventional welding of galvanized workpieces can be problematic. Specifically, during welding the zinc in the galvanization vaporizes and this zinc vapor can become trapped in the weld puddle as the puddle solidifies, causing porosity. This porosity adversely affects the strength of the weld joint. Because of this, existing welding techniques require a first step of removing the galvanization or welding through the galvanization at lower processing speeds and with some level of defects—which is inefficient and causes delay, or requires the welding process to proceed slowly. By slowing the process the weld puddle remains molten for a longer period of time allowing the vaporized zinc to escape. However, because of the slow speed production rates are slow and the overall heat input into the weld can be high. Other coatings which can cause similar issues include, but are not limited to: paint, stamping lubricants, glass linings, aluminized coatings, surface heat treatment, nitriding or carbonizing treatments, cladding treatments, or other vaporizing coatings or materials. Exemplary embodiments of the present invention eliminate these issues, as explained below.

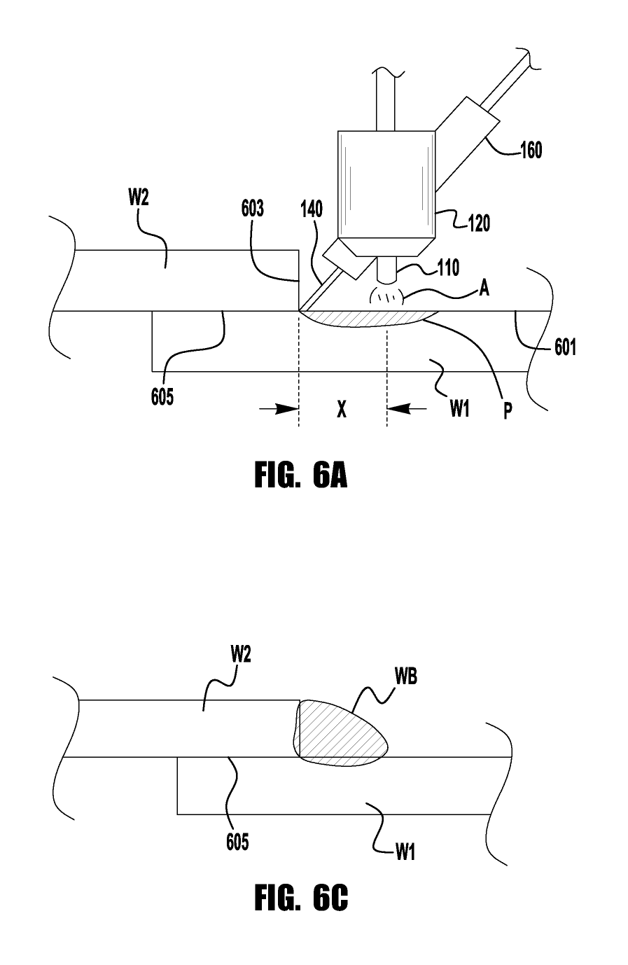

Turning to FIGS. 6A and 6B (cross-section and asymmetric view, respectively) a representative welding lap joint is shown. In this figure two coated (e.g., galvanized) workpieces W1/W2 are to be joined with a lap weld. The lap joint surfaces 601 and 603 are initially covered with the coating as well as the surface 605 of workpiece W1. In a typical welding operation (for example GMAW) portions of the covered surface 605 are made molten. This is because of the typical depth of penetration of a standard welding operation. Because the surface 605 is melted the coating on the surface 605 is vaporized, but because of the distance of the surface 605 from the surface of the weld pool is large, the gases can be trapped as the weld pool solidifies. With embodiments of the present invention this does not occur.

As shown in FIGS. 6A and 6BA the arc welding is directed by the arc welding subsystem such that the arc A is displaced from the center of the lap joint by a distance X, where the center of the lap joint is the represented by the intersection point between the surface 603 and 601. That is, the arc welding consumable 110 is offset (by a distance X) from the hot wire consumable 140 in a direction that is normal (perpendicular to) the travel direction of the hot wire consumable 110. However, unlike traditional tandem welding operations the hot wire 140 is directed general at the center of the joint (where the joint in FIGS. 6A and 6B is the meeting corner of surfaces 603 and 601. That is, the arc welding operation is directed more on the surface 601 such that the majority or all of the puddle P is on the surface 601. By using a tandem offset configuration as shown in FIGS. 6A and 6B the majority of the heat from the arc A is directed at the surface 601 and minimizes the penetration into the surface 605. By minimizing this penetration into the joint (penetration into surface 605) any material on the surface 605 (such as zinc, etc.) is not vaporized and thus greatly minimizes the porosity produced in the weld joint. Further, because of aspects of the present invention, the puddle remains liquid for additional time with the addition of the hot wire without significantly adding more heat to the operation—which would vaporize more of the coating (e.g., zinc). This increased molten time (with no significant amounts of additional heat) allows any vaporized coating (e.g., zinc) in the puddle to escape from the puddle before solidification.

It is noted that although a separate torch 120 and tube 160 are shown in FIGS. 6A and 6B each of the wires 110 and 140 can be delivered through a single torch head which directs each wire to the desired position.

In exemplary embodiments of the present invention, the offset distance X for the center of the arc A is such that the edge of the puddle P is close to, or just in contact with the surface 603 of the workpiece W2. In some exemplary embodiments, the distance X is within the range of 1.5 to 5 times the diameter of the consumable 110. In other exemplary embodiments, the distance X is within the range of 2 to 4 times the diameter of the arc welding consumable 110. In other exemplary embodiments, the offset X is in the range of 2 to 5 mm, and in further exemplary embodiments the offset is in the range of 2 to 3 mm. In a GMAW type welding operation the distance X is measured from the joint center line 613 (intersection of surfaces 603 and 601) to the centerline of the consumable 110 (see 611), while in a GTAW type operation the distance X is measured from the joint centerline to the center of the electrode during the welding operation. Further, in exemplary embodiments of the present invention, the trailing hot wire 140 is directed at the centerline of the joint. In exemplary embodiments of the present invention the hot wire 140 is directed at the joint such that the centerline of the wire 140 intersects the centerline of the joint. In some exemplary embodiments of the present invention, the wire 140 is directed at the joint such that the centerline of the wire 140 is at or less than 1× the diameter of the wire 140 off of the centerline of the joint.

Further, because the hot wire 140 is deposited into the puddle P created by the arc A the hot wire 140 is trailing the arc A by a distance to ensure that this is the case. In exemplary embodiments of the present invention, the hot wire 140 trails the arc A by a distance in the range of 2 to 9 mm. In further exemplary embodiments, the distance is in the range of 3 to 6 mm. In some exemplary embodiments, the heat from the arc can assist in the melting of the hot wire 140, but the hot wire 140 should not be too close to the arc A such that the arc jumps to the hot wire 140. Further, the trail distance should be sufficient that the hot wire 140 is deposited into the molten puddle created by the arc A.

FIG. 6C depicts an illustrative depiction of a weld bead created with embodiments of the present invention described herein. As shown, the weld bead WB bonds to each of the workpieces W1 and W2, but the penetration into the workpiece W2 is much smaller compared to workpiece W1. Therefore, to the extent that the surface 605 is coated (with zinc, etc.) the minimal penetration ensures that porosity is greatly reduced during the welding process. Furthermore, because of the minimal penetration into the joint (toward surface 605) embodiments of the present invention can weld at speeds much higher than known systems, and on workpieces which are thin. This is at least in part due to the low heat input experienced by methods described herein—this will be discussed in more detail below. For example, embodiments of the present invention can weld at travel speeds in the range of 40 to 70 ipm on plate with a thickness in the range of 0.8 to 2 mm, with little or no porosity and can join 2 mm plate with a gap in between of up to 3 mm. Such performance is not achievable with known systems. Further, this performance can be attained on work pieces as thin as 0.8 mm with minimal distortion. This performance is achieved because it has been discovered that the current waveforms of each for each of the arc A and for the hot wire 140 (which will be described in more detail below) interact with each other in such a way that the arc A is drawn toward the hot wire 140 and thus the joint centerline during the welding operation. That is, during welding the arc A is drawn back into the joint centerline so that it allows for proper formation of the weld bead WB, as shown in FIG. 6C. However, because the arc A is offset as described above the majority of the penetration is remote from the center of the joint and the surface 605. Because of this, there is minimal vaporization of any coating on the surface 605 and thus minimal adverse effects from the vaporization of this coating.

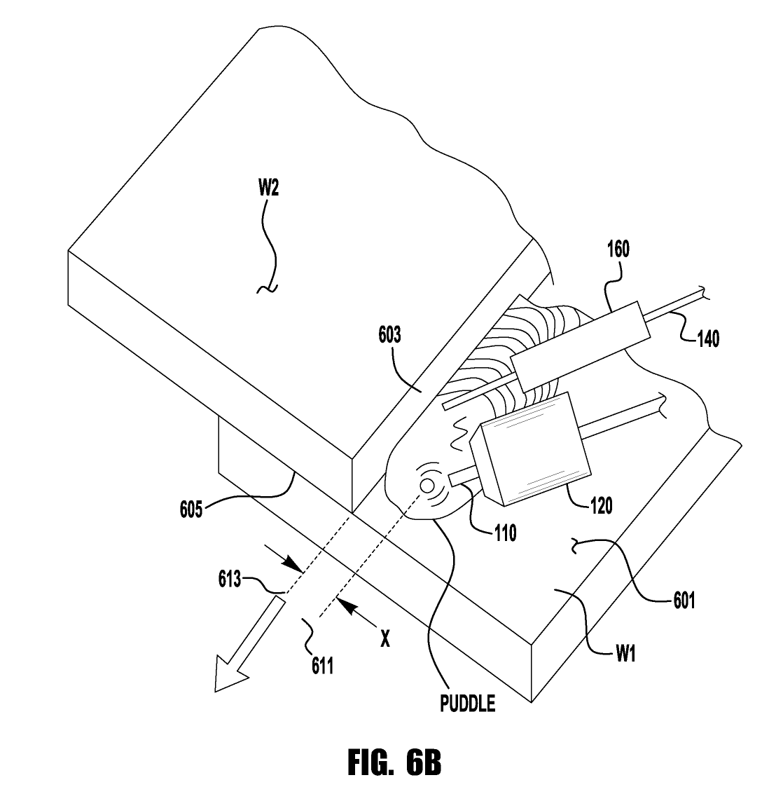

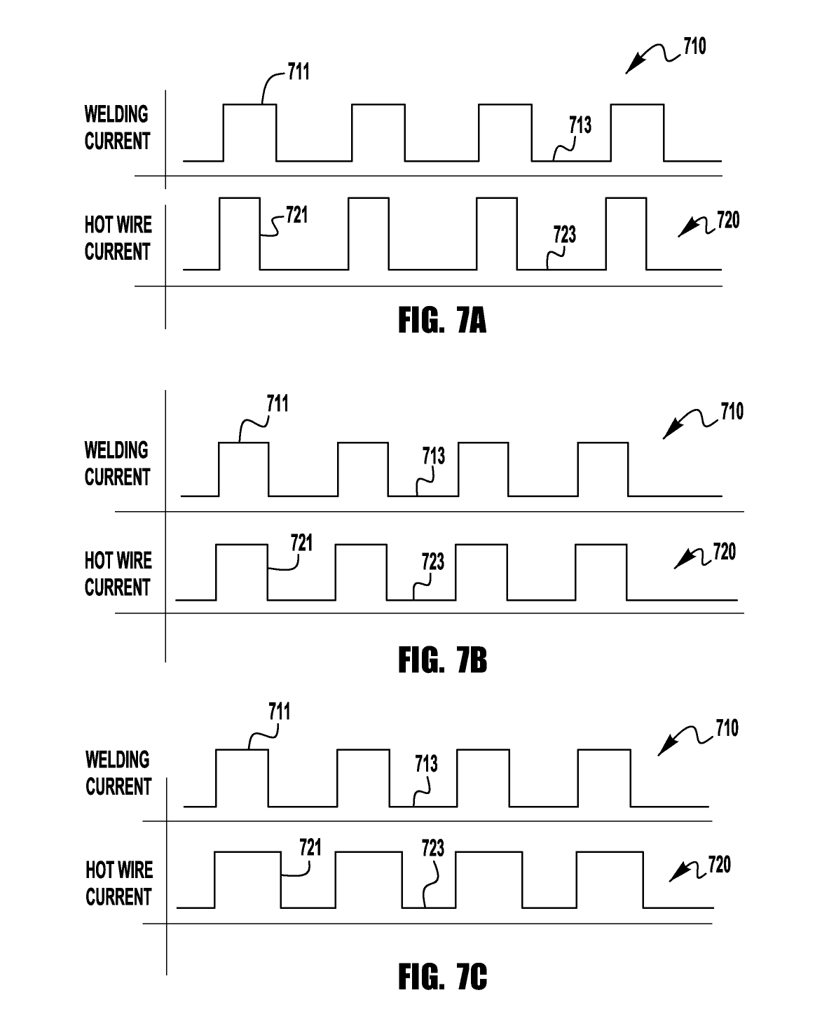

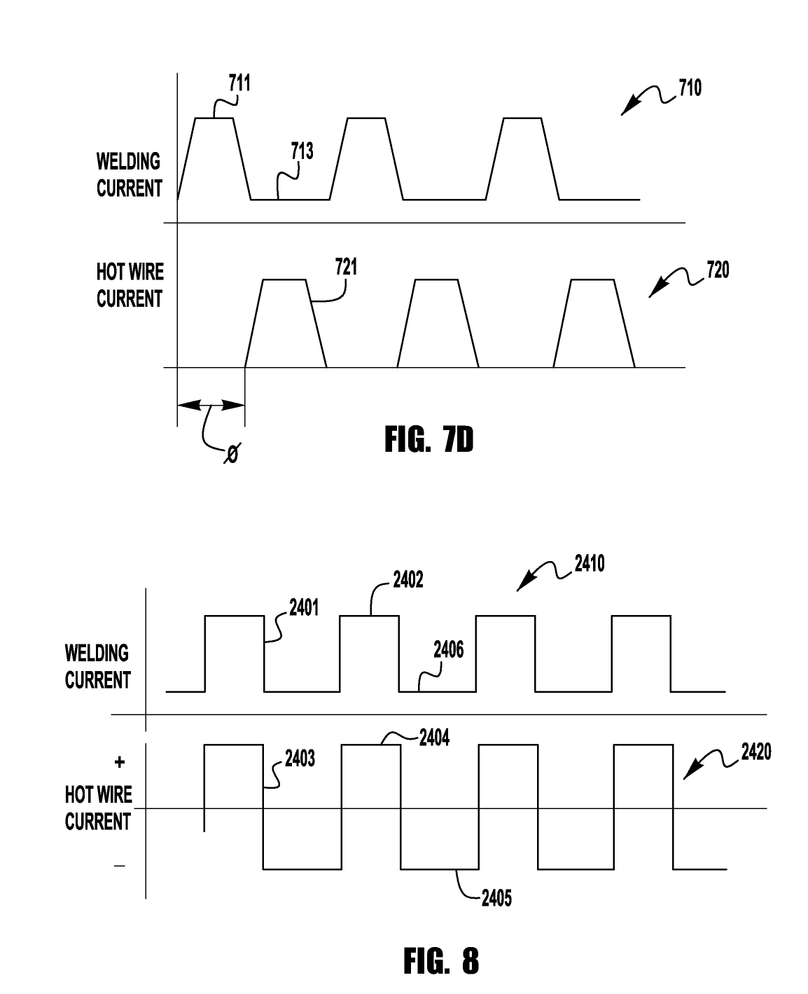

As discussed above, it has been discovered that current waveforms for each of the hot wire 140 and the weld wire 110 can interact with each other—via their respective magnetic fields—such that the lead arc/puddle is pulled toward the joint by the hot wire current to provide an adequately welded joint with minimal penetration in the surface 605 to minimize the creation of porosity. FIGS. 7A through 7D depict exemplary embodiments of current waveforms for each of the hot wire and the welding operation.

As shown, the current waveforms are pulse-type waveforms and the waveforms are synchronized. Synchronization can be achieved via various methods. For example, the sensing and current controller 195 can be used to control the operation of the power supplies 130 and 170 to synchronize the currents. Alternatively a master-slave relationship can also be utilized where one of the power supplies is used to control the output of the other. The control of the relative currents can be accomplished by a number of methodologies including the use of state tables or algorithms that control the power supplies such that their output currents are synchronized for a stable operation. This will be discussed relative to FIGS. 7A-C. For example, a dual-state based system and devices similar to that described in US Patent Publication No. 2010/0096373 can be utilized. US Patent Publication No. 2010/0096373, published on Apr. 22, 2010, is incorporated herein by reference in its entirety.

Each of FIGS. 7A-D depicts exemplary current waveforms. FIG. 7A depicts an exemplary welding waveform 710 (either GMAW or GTAW) which uses current pulses 711 to aid in the transfer of droplets from the wire 110 to the puddle. The pulses are separated by a background current 713, which is generally known. Of course, the waveform shown is exemplary and representative and not intended to be limiting, for example the current waveforms can be that for pulsed spray transfer, pulse welding, surface tension transfer welding, etc. The hot wire power supply 170 outputs a current waveform 720 which also has a series of pulses 721 to heat the wire 140, through resistance heating as generally described above. The current pulses 721 are separated by a background level 723 of a lesser current level. In some exemplary embodiments, the hot wire current 720 may not have a background current level between pulses, where the current is dropped to zero in between pulses. In other embodiments, the background 723 for the hot wire current can be low (compared to typical background current levels for welding waveforms) and can be in the range of 5 to 15% of the peak current level for the hot-wire pulses 721. As generally described previously, the waveform 720 is used to heat the wire 140 to at or near its melting temperature and uses the pulses 721 and background to heat the wire 140 through resistance heating. As shown in FIG. 7A the pulses 711 and 721 from the respective current waveforms are synchronized such that they are in phase with each other. In this exemplary embodiment, the current waveforms are controlled such that the current pulses 711/721 have a similar, or the same, frequency and are in phase with each other as shown. Further, in the embodiment shown in FIG. 7A, the peak current pulse width of the heating pulses 721 are less than the peak current pulse width of the welding pulses 711. In such embodiments, the peak current pulse width of the heating pulses 721 is in the range of 75 to 90% of the peak current pulse width of the welding pulses 711. It was discovered that having the waveforms in phase produces a stable and consistent operation where the welding arc is pulled toward the weld joint by the hot wire current when the hot wire and welding operation are positioned offset as described herein.

FIG. 7B depicts waveforms from another exemplary embodiment of the present invention. In this embodiment, the heating current waveform 720 is controlled/synchronized such that the pulses 721 are in-phase with the pulses 711 and the pulses have the same pulse width. That is, the pulses 711/721 have the same duration their respective peak current levels. In other exemplary embodiments, the pulses can have a different pulse width. However, in such embodiments the peak current duration for the hot-wire pulses 721 are within +/−10% of the peak current duration of the welding pulses 711. In other exemplary embodiments, the difference is +/−5%. Also, as shown, embodiments of the waveforms shown in FIG. 7B use the same frequency as well.

FIG. 7C depicts another exemplary embodiment of the present invention, where the hot wire current 720 is synchronized with the welding waveform 710 as described above, where the waveforms have the same frequency and are synchronized. However, in the embodiment shown in FIG. 7C the peak current pulse width of the hot-wire pulses 721 are larger than that of the peak current pulse widths of the welding pulses 711. In exemplary embodiments, the peak current pulse width of the hot-wire pulses 721 is in the range of 10 to 25% larger than the peak current pulse widths of the welding pulses 711.

In addition to the waveforms being synchronized as described above, in exemplary embodiments the pulses 711/721 in the respective waveforms have very similar, if not the same, peak current levels. That is, in some embodiments each of the waveforms 710 and 720 have the same peak current levels. In other exemplary embodiments, the peak current level of the hot wire pulses 721 are within +/−10% of the peak current level of the welding pulses 711.

FIG. 7D depicts further exemplary waveforms 710 and 720. In this embodiment, the waveforms 710 and 720 are synchronized such that they are offset by a phase angle φ, such that the pulses 721 of the hot wire current 720 are offset from the pulses 711 of the arc current 710. (It is noted that the hot wire current 720 is shown with no background current, which as discussed above, can be used in some embodiments). In exemplary embodiments, the phase angle φ is in the range of 340 to 20 degrees. In other exemplary embodiments, the phase angle is in the range of 350 degrees. In such embodiments, the respective peaks of the pulses 711 and 721 occur at or near the same time. As such, because of their respective magnetic fields the high current peak arc is pulled towards the hot wire and thus the joint. In some embodiments, if a high hot-wire current peak occurs during the background 723 of the arc welding waveform 710 the arc can become unstable relative to the puddle, which can adversely affect the quality of the weld.

In exemplary embodiments of the present invention, the arc welding waveform utilizes a voltage in the range of 22 to 28V, while the hot-wire waveform utilizes a voltage in the range of 2 to 8V. In exemplary embodiments using a GMAW type welding system as the lead process, the voltage range can be in the range of 18 to 28V, while using GTAW type systems the voltage can be in the range of 8 to 15V. In using PAW systems, the known voltage ranges for PAW type operations can be used.

Because of various attributes of embodiments of the present invention, and the utilization of exemplary waveforms described above, embodiments of the present invention can weld at high speeds with low heat input into the work piece. Because of this, embodiments of the present invention can weld on thin work pieces without worry of distortion, burnthrough or other adverse effects from high heat input into a workpiece. In fact, in exemplary embodiments of the present invention a heat input (in joules/in) ratio of the arc welding process to the hot-wire process can be at least 2:1. In other exemplary embodiments, the ratio is at least 3:1. In further embodiments, the heat input ratio can be in the range of 2:1 to 10:1. In additional exemplary embodiments, the ratio is in the range of 3:1 to 7:1. However, even though the heat input ratio can be at least 2:1, embodiments of the present invention can maintain a high deposition rate for each of the wires 110 and 140, and in fact the deposition rates of the lead wire (arc) to the trail wire (hot wire) can be 1:1. In other exemplary embodiments, the deposition ratio of the lead wire to the trail wire can be in the range of 0.85:1 to 1:15:1, even though the power ratio is at least 2:1. For example, an embodiment of the present invention can have a lead input power in the range of 5.7 to 6.7 KW, where the trail input power is in the range of 0.8 to 2.3 KW, where each of the lead and trail wires are deposited at a rate in the range of 580 to 650 ipm. In some embodiments, each of the lead wire (110) and the trail wire (140) can be deposited at the same rate (ipm), while in other embodiments the trail wire (140) can be deposited faster (ipm) then the lead wire (110). In exemplary embodiments, the trail wire (140) can be deposited in the range of 10 to 50 ipm faster than the lead wire (110). Thus, a very high deposition rate can be achieved with very low heat input and controlled penetration into the joint to minimize porosity, etc. With the above described systems and methods, exemplary embodiments of the present invention can utilize a heat input ratio of lead arc to hot wire in the range of 2:1 to 10:1, while maintaining a deposition rate ratio of the lead arc electrode to the hot wire electrode in the range of 0.85:1 to 1.15:1. In other exemplary embodiments, the heat input ratio is in the range of 3:1 to 7:1. In further exemplary embodiments, where more heat and/or lead penetration is desired, embodiments of the present invention can have a lead to trail deposition ratio in the range of 1:1 to 6:1. In such embodiments, as the ratio increases more heat and penetration will be delivered into the joint via the lead process, and as the ratio approaches 1:1 the heat input and penetration is reduced.

In exemplary embodiments of the present invention, each of the lead 110 and trail 140 wires can have the same diameter and chemistry. However, in other exemplary embodiments, the diameters can be different (e.g., 0.035″ trail and 0.045″ lead), and the chemistries can also be different, depending on the desired weld attributes. Of course, in other embodiments, the lead wire can be smaller in diameter.

It should be noted that although the heating current is shown as a pulsed current, for some exemplary embodiments the heating current can be constant power as described previously. The hot-wire current can also be a pulsed heating power, constant voltage, a sloped output and/or a joules/time based output.

As explained herein, to the extent both currents are pulsed currents they are to be synchronized to ensure stable operation. There are many methods that can be used to accomplish this, including the use of synchronization signals (see e.g., FIG. 1B). For example, the controller 195 (which can be integral to either or the power supplies 170/130) can set a synchronization signal to start the pulsed arc peak and also set the desired start time for the hot wire pulse peak. As explained above, in some embodiments, the pulses will be synchronized to start at the same time, while in other embodiments the synchronization signal can set the start of the pulse peak for the hot wire current at some duration after the arc pulse peak—the duration would be sufficient to obtained the desired phase angle for the operation.

FIG. 8 depicts other exemplary waveforms that can be used with embodiments of the present invention. Like the embodiments described above, the arc welding current 2410 has a plurality of pulses 2401 with a peak current 2402 and a background current 2406. However, unlike the embodiments discussed in FIGS. 7A to 7D the hot wire current 2420 is an AC current having a plurality of pulses 2403, some with positive peaks 2404 and some with negative peaks 2405. This can be utilized to aid in control of the arc A during welding. As discussed above, embodiments of the present invention can utilize a phase angle in the range of 340 to 20 degrees. Further, in exemplary embodiments, the negative peaks 2405 can have a smaller peak current level than the positive peaks 2404. This can be beneficial do to the fact that in the shown embodiment the negative peaks 2405 occur during the background 2406 of the arc welding current 2410. Although in FIG. 8, it is shown that the negative pulses begin shortly after the ending of the positive pulses, in other exemplary embodiments time gap can exist between the alternating pulses.

As described previously, the filler wire 140—which is resistance heated as described previously—is directed to the weld puddle to provide the needed filler material for the weld bead. Further, unlike most welding processes the filler wire 140 makes contact and is plunged into the weld puddle during the welding process. This is because this process does not use a welding arc to transfer the filler wire 140 but rather simply melts the filler wire into the weld puddle. Thus, embodiments of the present invention can have high material deposition rates at high speeds compared to known arc welding systems.

Because the filler wire 140 is preheated to at or near its melting point its presence in the weld puddle will not appreciably cool or solidify the puddle and is quickly consumed into the weld puddle. The general operation and control of the filler wire 140 is as described previously with respect to the overlaying embodiments.

Because the depth of weld puddle penetration can be precisely controlled the speed of welding coated workpieces can be greatly increased, while significantly minimizing or eliminating porosity. Some arc welding system can achieve good travel speeds for welding, but at the higher speeds problems can occur such as porosity and spatter. In exemplary embodiments of the present invention, very high travel speeds can be achieved with little or no porosity or spatter (as discussed herein) and in fact travel speeds of over 30 inches/min can be easily achieved for many different types of welding operations. Embodiments of the present invention can achieve welding travel speeds over 60 inches/minute. Further, other embodiments can achieve travel speeds in the range of 80 to 110 inches/min with minimal or no porosity or spatter, as discussed herein. Of course, the speeds achieved will be a function of the workpiece properties (thickness and composition) and the wire properties (e.g., dia.), but these speeds are readily achievable in many different welding and joining applications when using embodiments of the present invention. Additionally, these travel speeds can be achieved without removing any surface coating prior to the creation of the weld puddle and welding. In fact, coating thicknesses in the range of 2 to 15 microns can be easily welding with embodiments of the present invention. Of course, it is contemplated that higher travel speeds can be achieved. Furthermore, because of the reduced heat input into the weld these high speeds can be achieved in thinner workpieces, which typically have a slower weld speed because heat input must be kept low to avoid distortion. Not only can embodiments of the present invention achieve the above described high travel speeds with little or no porosity or spatter, but they can also achieve very high deposition rates, with low admixture.

As explained above, high travel speeds can be achieved with little or no porosity and little or no spatter. Porosity of a weld can be determined by examining a cross-section and/or a length of the weld bead to identify porosity ratios. The cross-section porosity ratio is the total area of porosity in a given cross-section over the total cross-sectional area of the weld joint at that point. The length porosity ratio is the total accumulated length of pores in a given unit length of weld joint. Embodiments of the present invention can achieve the above described travel speeds with a cross-sectional porosity between 0 and 20%. Thus, a weld bead with no bubbles or cavities will have a 0% porosity. In other exemplary embodiments, the cross-sectional porosity can be in the range of 0 to 10%. It is understood that in some welding applications some level of porosity is acceptable. Further, in exemplary embodiments of the invention the length porosity of the weld is in the range of 0 to 20%, and can be 0 to 10% in other exemplary embodiments.

Furthermore, embodiments of the present invention can weld at the above identified travel speeds with little or no spatter. Spatter occurs when droplets of the weld puddle are caused to spatter outside of the weld zone. When weld spatter occurs it can compromise the quality of the weld and can cause production delays as it must be typically cleaned off of the workpieces after the welding process. Thus, there is great benefit to welding at high speed with no spatter. Embodiments of the present invention are capable of welding at the above high travel speeds with a spatter factor in the range of 0 to 100, where the spatter factor is the weight of the spatter over a given travel distance X (in mg) over the weight of the consumed filler wire 140 over the same distance X (in Kg). That is:

Spatter Factor=(spatter weight(mg)/consumed filler wire weight(Kg))

The distance X should be a distance allowing for a representative sampling of the weld joint. That is, if the distance X is too short, e.g., 0.5 inch, it may not be representative of the weld. Thus, a weld joint with a spatter factor of 0 would have no spatter for the consumed filler wire over the distance X, and a weld with a spatter of factor of 100 had 100 mg of spatter for 1 Kg of consumed filler wire. In an exemplary embodiment of the present invention, the spatter factor is in the range of 0 to 50. In a further exemplary embodiment, the spatter factor is in the range of 0 to 10. It should be noted that embodiments of the present invention can achieve the above described spatter factor ranges with or without the use of any external shielding for the hot wire consumable—which includes either shielding gas or flux shielding. Furthermore, the above spatter factor ranges can be achieved when welding coated workpieces, including workpieces which are galvanized—without having the galvanization removed prior to the welding operation.

There are a number of methods to measure spatter for a weld joint. One method can include the use of a “spatter boat.” For such a method a representative weld sample is placed in a container with a sufficient size to capture all, or almost all, of the spatter generated by a weld bead. The container or portions of the container—such as the top—can move with the weld process to ensure that the spatter is captured. Typically the boat is made from copper so the spatter does not stick to the surfaces. The representative weld is performed above the bottom of the container such that any spatter created during the weld will fall into the container. During the weld the amount of consumed filler wire is monitored. After the weld is completed the spatter boat is to be weighed by a device having sufficient accuracy to determine the difference, if any, between the pre-weld and post-weld weight of the container. This difference represents the weight of the spatter and is then divided by the amount, in Kg, of the consumed filler wire. Alternatively, if the spatter does not stick to the boat the spatter can be removed and weighed by itself.

Further benefits of embodiments of the present invention include being able to use minimal amounts of shielding gas when welding. That is, only the welding process need be shielded, as no shielding gas need be directed to the hot-wire process.

It is noted that embodiments of the present invention are not limited to using a single hot wire consumable during the operation as depicted in FIGS. 1A and 1B. In further exemplary embodiments, an additional hot wire electrode can be deposited into the puddle at the same time to increase the overall deposit rate. For example, in some embodiments an additional electrode can be deposited in front of the arc welding operation. Of course, the heating current and orientation of the additional hot wire electrode should be use a peak current level, synchronization and orientation so as to not render the arc welding operation unstable. In one exemplary embodiment, the additional hot wire can be positioned upstream of the arc welding electrode and approach the puddle at a shallow angle relative to the surface of the workpiece, and would also be directed at the joint like the trailing hot wire electrode.

Exemplary embodiments for joining/welding can be similar to that shown in FIGS. 1A and 1B. As described above a hot wire power supply 170 is provided which provides a heating current to the filler wire 140. The current pass from the contact tip 160 (which can be of any known construction) to the wire 140 and then into the workpiece. This resistance heating current causes the wire 140 between the tip 160 and the workpiece to reach a temperature at or near the melting temperature of the filler wire 140 being employed. Of course, the melting temperature of the filler wire 140 will vary depending on the size and chemistry of the wire 140. Accordingly, the desired temperature of the filler wire during welding will vary depending on the wire 140. As will be further discussed below, the desired operating temperature for the filler wire can be a data input into the welding system so that the desired wire temperature is maintained during welding. In any event, the temperature of the wire should be such that the wire is consumed into the weld puddle during the welding operation. In exemplary embodiments, at least a portion of the filler wire 140 is solid as the wire enters the weld puddle. For example, at least 30% of the filler wire is solid as the filler wire enters the weld puddle.

In an exemplary embodiment of the present invention, the hot wire power supply 170 supplies a current which maintains at least a portion of the filler wire at a temperature at or above 75% of its melting temperature. For example, when using a mild steel filler wire 140 the temperature of the wire before it enters the puddle can be approximately 1,600° F., whereas the wire has a melting temperature of about 2,000° F. Of course, it is understood that the respective melting temperatures and desired operational temperatures will varying on at least the alloy, composition, diameter and feed rate of the filler wire. In another exemplary embodiment, the power supply 170 maintains a portion of the filler wire at a temperature at or above 90% of its melting temperature. In further exemplary embodiments, portions of the wire are maintained at a temperature of the wire which is at or above 95% of its melting temperature. In exemplary embodiments, the wire 140 will have a temperature gradient from the point at which the heating current is imparted to the wire 140 and the puddle, where the temperature at the puddle is higher than that at the input point of the heating current. It is desirable to have the hottest temperature of the wire 140 at or near the point at which the wire enters the puddle to facilitate efficient melting of the wire 140. Thus, the temperature percentages stated above are to be measured on the wire at or near the point at which the wires enters the puddle. By maintaining the filler wire 140 at a temperature close to or at its melting temperature the wire 140 is easily melted into or consumed into the weld puddle created by the welding arc. That is, the wire 140 is of a temperature which does not result in significantly quenching the weld puddle when the wire 140 makes contact with the puddle. Because of the high temperature of the wire 140 the wire melts quickly when it makes contact with the weld puddle. It is desirable to have the wire temperature such that the wire does not bottom out in the weld pool—make contact with the non-melted portion of the weld pool. Such contact can adversely affect the quality of the weld.

As described previously, in some exemplary embodiments, the complete melting of the wire 140 can be facilitated only by entry of the wire 140 into the puddle. However, in other exemplary embodiments the wire 140 can be completely melted by a combination of the puddle and the heat from the arc generated in the welding process.

As also discussed previously with regard to FIG. 1, the power supply 170 and the controller 195 control the heating current to the wire 140 such that, during welding, the wire 140 maintains contact with the workpiece and no arc is generated. Contrary to arc welding technology, the presence of an arc when welding with embodiments of the present invention can result in significant weld deficiencies. Thus, in some embodiments (as those discussed above) the voltage between the wire 140 and the weld puddle should be maintained at or near 0 volts—which indicates that the wire is shorted to or in contact with the workpiece/weld puddle.

However, in other exemplary embodiments of the present invention it is possible to provide a current at such a level so that a voltage level above 0 volts is attained without an arc being created. By utilizing higher currents values it is possible to maintain the electrode 140 at temperatures at a higher level and closer to an electrode's melting temperature. This allows the welding process to proceed faster. In exemplary embodiments of the present invention, the power supply 170 monitors the voltage and as the voltage reaches or approaches a voltage value at some point above 0 volts the power supply 170 stops flowing current to the wire 140 to ensure that no arc is created. The voltage threshold level will typically vary, at least in part, due to the type of welding electrode 140 being used. For example, in some exemplary embodiments of the present invention the threshold voltage level is in the range of 12 to 19 volts. In another exemplary embodiment, the threshold level is in the range of 15 to 19 volts. For example, when using mild steel filler wires the threshold level for voltage will be of the lower type, while filler wires which are for stainless steel welding can handle the higher voltage before an arc is created.

In further exemplary embodiments, rather than maintaining a voltage level below a threshold, such as above, the voltage is maintained in an operational range. That is the average running voltage of the waveform is maintained at a desired level or within a desired range. In such an embodiment, it is desirable to maintain the average running voltage above a minimum amount—ensuring a high enough current to maintain the filler wire at or near its melting temperature but below a voltage level such that no welding arc is created. For example, the average running voltage can be maintained in a range of 2 to 10 volts. In a further exemplary embodiment the average running voltage is maintained in a range of 2 to 8 volts. It is noted, as generally understood this average running voltage is the average running voltage drop across the hot wire from the contact tip 160 to the workpiece/puddle. Of course, the desired operational range can be affected by the filler wire 140 used for the welding operation, such that a range (or threshold) used for a welding operation is selected, at least in part, based on the filler wire used or characteristics of the filler wire used. In utilizing such a range the bottom of the range is set to a voltage at which the filler wire can be sufficiently consumed in the weld puddle and the upper limit of the range is set to a voltage such that the creation of an arc is avoided. It is noted that above voltage ranges are average running voltages over a period of time, unlike the arc detection threshold voltages, which are higher and are based off of a detected instantaneous voltage. Because the creation of an arc is a rapid event and the arc detection is based on an instantaneous voltage, so that the arc can be suppressed quickly. As stated above, in exemplary embodiments, the instantaneous arc detection voltage level can be in the range of 12 to 19 volts.

As described previously, as the voltage exceeds a desired threshold voltage the heating current is shut off by the power supply 170 such that no arc is created. This aspect of the present invention will be discussed further below.

In the many embodiments described above the power supply 170 contains circuitry which is utilized to monitor and maintain the voltage as described above. The construction of such type of circuitry is known to those in the industry. However, traditionally such circuitry has been utilized to maintain voltage above a certain threshold for arc welding.

In further exemplary embodiments, the heating current can also be monitored and/or regulated by the power supply 170. This can be done in addition to monitoring voltage, power, or some level of a voltage/amperage characteristic as an alternative. That is, the current can be maintained at a desired level or levels to ensure that the wire 140 is maintained at an appropriate temperature—for proper consumption in the weld puddle, but yet below an arc generation current level. For example, in such an embodiment the voltage and/or the current are being monitored to ensure that either one or both are within a specified range or below a desired threshold. The power supply then regulates the current supplied to ensure that no arc is created but the desired operational parameters are maintained.

In yet a further exemplary embodiment of the present invention, the heating power (V×I) can also be monitored and regulated by the power supply 170. Specifically, in such embodiments the voltage and current for the heating power is monitored to be maintained at a desired level, or in a desired range. Thus, the power supply not only regulates the voltage or current to the wire, but can regulate both the current and the voltage. That is, like the voltage embodiment described above, the power supply 170 monitors the average running power over the hot wire 140 between the contact tip 160 and the workpiece/puddle. In exemplary embodiments, the heating signal is controlled such that the average running power is maintained in the range of 300 to 2500 watts, and in other embodiments the output is maintained such that the average running power in the range of 700 to 1700 watts. Such an embodiment may provide improved control over the welding system. In such embodiments the heating power to the wire can be set to an upper threshold level or an optimal operational range such that the power is to be maintained either below the threshold level or within the desired range (similar to that discussed above regarding the voltage). Again, the threshold or range settings will be based on characteristics of the filler wire and welding being performed, and can be based—at least in part—on the filler wire selected. For example, it may be determined that an optimal power setting for a mild steel electrode having a diameter of 0.045″ is in the range of 1950 to 2,050 watts. The power supply will regulate the voltage and current such that the power remains in this operational range. Similarly, if the power threshold is set at 2,000 watts, the power supply will regulate the voltage and current so that the power level does not exceed but is close to this threshold.

In further exemplary embodiments of the present invention, the power supply 170 contains circuits which monitor the rate of change of the heating voltage (dv/dt), current (di/dt), and or power (dp/dt). Such circuits are often called premonition circuits and their general construction is known. In such embodiments, the rate of change of the voltage, current and/or power is monitored such that if the rate of change exceeds a certain threshold the heating current to the wire 140 is turned off.

In an exemplary embodiment of the present invention, the change of resistance (dr/dt) is also monitored. In such an embodiment, the resistance in the wire between the contact tip and the puddle is monitored. During welding, as the wire heats up it starts to neck down and has a tendency to form an arc, during which time the resistance in the wire increases exponentially. When this increase is detected the output of the power supply is turned off as described herein to ensure an arc is not created. Embodiments regulate the voltage, current, or both, to ensure that the resistance in the wire is maintained at a desired level.

In further exemplary embodiments of the present invention, rather than shutting off the heating current when the threshold level is detected, the power supply 170 reduces the heating current to a non-arc generation level. Such a level can be a background current level where no arc will be generated if the wire is separated from the weld puddle. For example, an exemplary embodiment of the present invention can have a non-arc generation current level in the range of 5 to 25 amps, where once an arc generation is detected or predicted, or an upper threshold (discussed above) is reached, the power supply 170 drops the heating current from its operating level to the non-arc generation level for either a predetermined amount of time (for example, 1 to 10 ms) or until the detected voltage, current, power, and/or resistance drops below the upper threshold. This non-arc generation threshold can be a voltage level, current level, resistance level, and/or a power level.

In another exemplary embodiment of the present invention, the output of the power supply 170 is controlled such that no substantial arc is created during the welding operation. In some exemplary welding operations the power supply can be controlled such that no substantial arc is created between the filler wire 140 and the puddle. It is generally known that an arc is created between a physical gap between the distal end of the filler wire 140 and the weld puddle. As described above, exemplary embodiments of the present invention prevent this arc from being created by keeping the filler wire 140 in contact with the puddle. However, in some exemplary embodiments the presence of an insubstantial arc will not compromise the quality of the weld. That is, in some exemplary welding operations the creation of an insubstantial arc of a short duration will not result in a level of heat input that will compromise the weld quality. In such embodiments, the welding system and power supply is controlled and operated as described herein with respect to avoiding an arc completely, but the power supply 170 is controlled such that to the extent an arc is created the arc is insubstantial. In some exemplary embodiments, the power supply 170 is operated such that a created arc has a duration of less than 10 ms. In other exemplary embodiments the arc has a duration of less than 1 ms, and in other exemplary embodiments the arc has a duration of less than 300 μs. In such embodiments, the existence of such arcs does not compromise the weld quality because the arc does not impart substantial heat input into the weld or cause significant spatter or porosity. Thus, in such embodiments the power supply 170 is controlled such that to the extent an arc is created it is kept insubstantial in duration so that the weld quality is not compromised. The same control logic and components as discussed herein with respect to other embodiments can be used in these exemplary embodiments. However, for the upper threshold limit the power supply 170 can use the detection of the creation of an arc, rather than a threshold point (of current, power, voltage, resistance) below a predetermined or predicted arc creation point. Such an embodiment can allow the welding operation to operate closer to its limits.

Because the filler wire 140 is desired to be in a constantly shorted state (in constant contact with the weld puddle) the current tends to decay at a slow rate. This is because of the inductance present in the power supply, welding cables and workpiece. In some applications, it may be necessary to force the current to decay at a faster rate such that the current in the wire is reduced at a high rate. Generally, the faster the current can be reduced the better control over the joining method will be achieved. In an exemplary embodiment of the present invention, the ramp down time for the current, after detection of a threshold being reached or exceeded, is 1 millisecond. In another exemplary embodiment of the present invention, the ramp down time for the current is 300 microseconds or less. In another exemplary embodiment, the ramp down time is in the range of 300 to 100 microseconds.

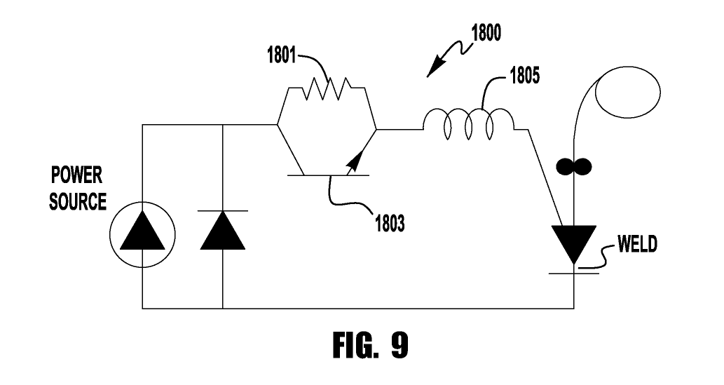

In an exemplary embodiment, to achieve such ramp down times, a ramp down circuit is introduced into the power supply 170 which aids in reducing the ramp down time when an arc is predicted or detected. For example, when an arc is either detected or predicted a ramp down circuit opens up which introduces resistance into the circuit. For example, the resistance can be of a type which reduces the flow of current to nearly 0 amps in 50 to 90 microseconds. A simplified example of such a circuit is shown in FIG. 9. The circuit 1800 has a resistor 1801 and a switch 1803 placed into the welding circuit such that when the power supply is operating and providing current the switch 1803 is closed. However, when the power supply stops supplying power (to prevent the creation of an arc or when an arc is detected) the switch opens forcing the induced current through the resistor 1801. The resistor 1801 greatly increases the resistance of the circuit and reduces the current at a quicker pace. Such a circuit type is generally known in the welding industry can be found a Power Wave® welding power supply manufactured by The Lincoln Electric Company, of Cleveland, Ohio, which incorporates surface-tension-transfer technology (“STT”). STT technology is generally described in U.S. Pat. Nos. 4,866,247, 5,148,001, 6,051,810 and 7,109,439, which are incorporated herein by reference in their entirety.

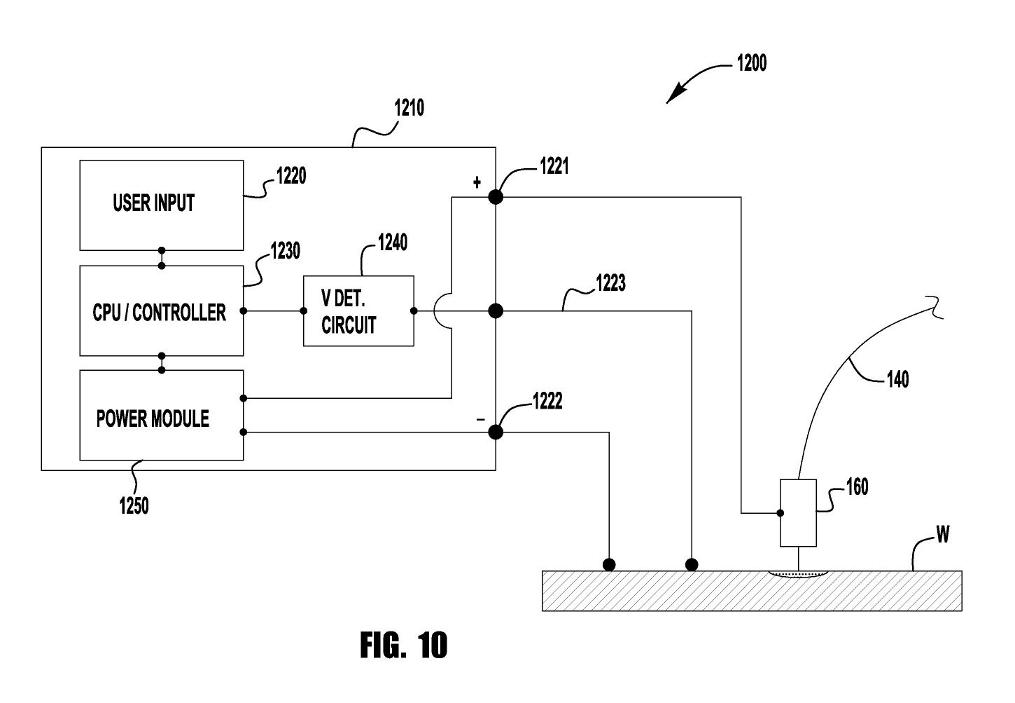

The above discussion can be further understood with reference to FIG. 10, in which an exemplary welding system is depicted. The system 1200 is shown having a hot wire power supply 1210 (which can be of a type similar to that shown as 170 in FIG. 1A). The power supply 1210 can be of a known welding power supply construction, such as an inverter-type power supply. Because the design, operation and construction of such power supplies are known they will not be discussed in detail herein. The power supply 1210 contains a user input 1220 which allows a user to input data including, but not limited to, wire feed speed, wire type, wire diameter, a desired power level, a desired wire temperature, voltage and/or current level. Of course, other input parameters can be utilized as needed. The user interface 1220 is coupled to a CPU/controller 1230 which receives the user input data and uses this information to create the needed operational set points or ranges for the power module 1250. The power module 1250 can be of any known type or construction, including an inverter or transformer type module.

The CPU/controller 1230 can determine the desired operational parameters in any number of ways, including using a lookup table, In such an embodiment, the CPU/controller 1230 utilizes the input data, for example, wire feed speed, wire diameter and wire type to determine the desired current level for the output (to appropriately heat the wire 140) and the threshold voltage or power level (or the acceptable operating range of voltage or power). This is because the needed current to heat the wire 140 to the appropriate temperature will be based on at least the input parameters. That is, an aluminum wire 140 may have a lower melting temperature than a mild steel electrode, and thus requires less current/power to melt the wire 140. Additionally, a smaller diameter wire 140 will require less current/power than a larger diameter electrode. Also, as the wire feed speed increases (and accordingly the deposition rate) the needed current/power level to melt the wire will be higher.

Similarly, the input data will be used by the CPU/controller 1230 to determine the voltage/power thresholds and/or ranges (e.g., power, current, and/or voltage) for operation such that the creation of an arc is avoided. For example, for a mild steel electrode having a diameter of 0.045 inches and a wire feed speed above 400 ipm can have an average running voltage range setting of 6 to 9 volts, where the power module 1250 is driven to maintain the voltage between 6 to 9 volts. In such an embodiment, the current, voltage, and/or power are driven to maintain a minimum of 6 volts—which ensures that the current/power is sufficiently high to appropriately heat the electrode—and keep the voltage at or below 9 volts to ensure that no arc is created and that a melting temperature of the wire 140 is not exceeded. Of course, other set point parameters, such as voltage, current, power, or resistance rate changes can also be set by the CPU/controller 1230 as desired.

As shown, a positive terminal 1221 of the power supply 1210 is coupled to the contact tip 160 of the hot wire system and a negative terminal of the power supply is coupled to the workpiece W. Thus, a heating current is supplied through the positive terminal 1221 to the wire 140 and returned through the negative terminal 1222. Such a configuration is generally known.

A feedback sense lead 1223 is also coupled to the power supply 1210. This feedback sense lead can monitor voltage and deliver the detected voltage to a voltage detection circuit 1240. The voltage detection circuit 1240 communicates the detected voltage and/or detected voltage rate of change to the CPU/controller 1230 which controls the operation of the module 1250 accordingly. For example, if the voltage detected is below a desired operational range, the CPU/controller 1230 instructs the module 1250 to increase its output (current, voltage, and/or power) until the detected voltage is within the desired operational range. Similarly, if the detected voltage is at or above a desired threshold the CPU/controller 1230 instructs the module 1250 to shut off the flow of current to the tip 160 so that an arc is not created. If the voltage drops below the desired threshold the CPU/controller 1230 instructs the module 1250 to supply a current or voltage, or both to continue the welding process. Of course, the CPU/controller 1230 can also instruct the module 1250 to maintain or supply a desired power level.

It is noted that the detection circuit 1240 and CPU/controller 1230 can have a similar construction and operation as the controller 195 shown in FIG. 1. In exemplary embodiments of the present invention, the sampling/detection rate is at least 10 KHz. In other exemplary embodiments, the detection/sampling rate is in the range of 100 to 200 KHz.

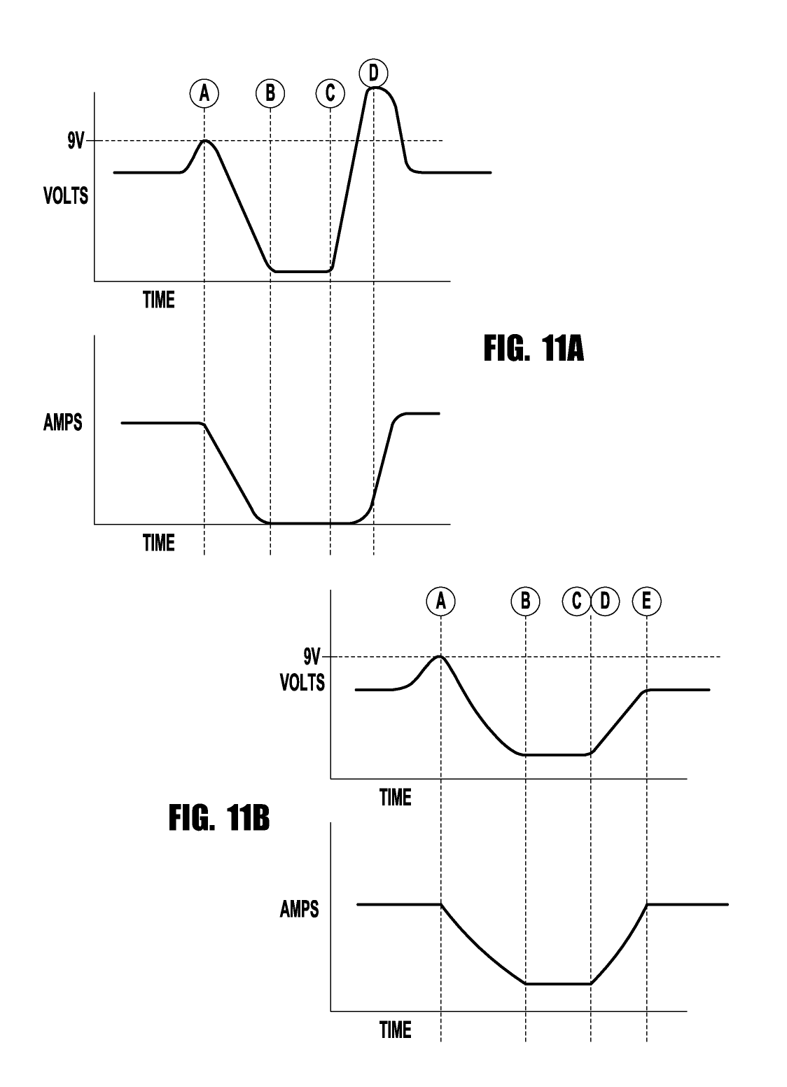

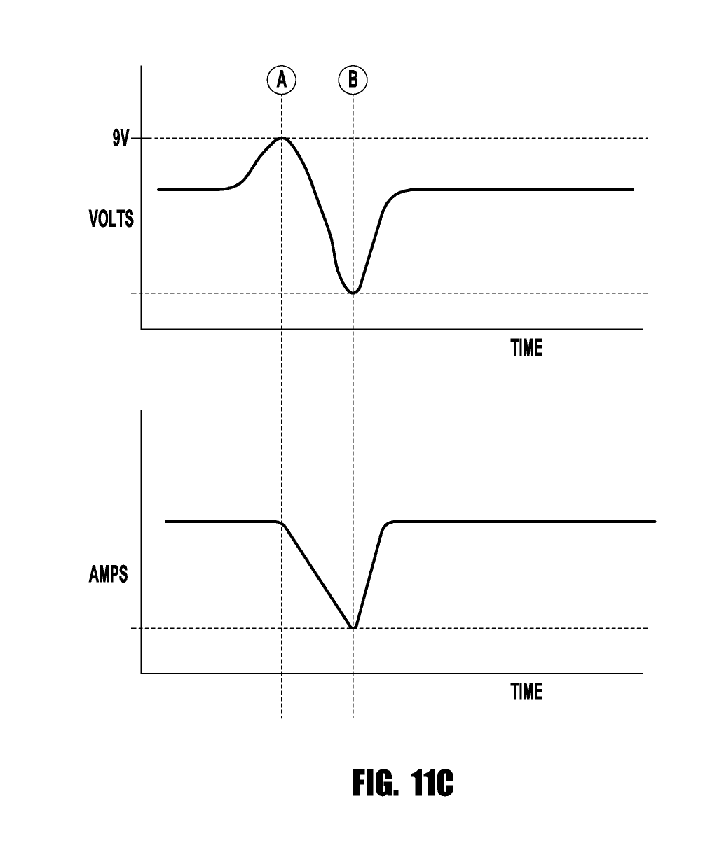

FIGS. 11A-C depict exemplary current and voltage waveforms utilized in embodiments of the present invention for the hot wire 140. Each of these waveforms will be discussed in turn. FIG. 11A shows the voltage and current waveforms for an embodiment where the filler wire 140 touches the weld puddle after the power supply output is turned back on—after an arc detection event. As shown, the output voltage of the power supply was at some operational level below a determined threshold (9 volts) and then increases to this threshold during welding. The operational level can be a determined level based on various input parameters (discussed previously) and can be a set operational voltage, current and/or power level. This operational level is the desired output of the power supply 170 for a given welding operation and is to provide the desired heating signal to the filler wire 140. During welding, an event may occur which can lead to the creation of an arc. In FIG. 11A the event causes an increase in the voltage, causing it to increase to point A. At point A the power supply/control circuitry hits the 9 volt threshold (which can be an arc detection point or simply a predetermined upper threshold, which can be below an arc creation point) and turns off the output of the power supply causing the current and voltage to drop to a reduced level at point B. The slope of the current drop can be controlled by the inclusion of a ramp down circuit (as discussed herein) which aids in rapidly reducing the current resultant from the system inductance. The current or voltage levels at point B can be predetermined or they can be reached after a predetermined duration in time. For example, in some embodiments, not only is an upper threshold for voltage (or current or power) set for welding, but also a lower non-arc generation level. This lower level can be either a lower voltage, current, or power level at which it is ensured that no arc can be created such that it is acceptable to turn back on the power supply and no arc will be created. Having such a lower level allows the power supply to turn back on quickly and ensure that no arc is created. For example, if a power supply set point for welding is set at 2,000 watts, with a voltage threshold of 11 volts, this lower power setting can be set at 500 watts. Thus, when the upper voltage threshold (which can also be a current or power threshold depending on the embodiment) is reached the output is reduced to 500 watts. (This lower threshold can also be a lower current or voltage setting, or both, as well). Alternatively, rather than setting a lower detection limit a timing circuit can be utilized to turn begin supplying current after a set duration of time. In exemplary embodiments of the present invention, such duration can be in the range of 500 to 1000 ms. In FIG. 11A, point C represents the time the output is again being supplied to the wire 140. It is noted that the delay shown between point B and C can be the result of an intentional delay or can simply be a result of system delay. At point C voltage is again being supplied to heat the filler wire. However, because the filler wire is not yet touching the weld puddle the voltage increases while the current does not. At point D the wire makes contact with the puddle and the voltage and current settle back to the desired operational levels. As shown, the voltage may exceed the upper threshold prior to contact at D, which can occur when the power source has an OCV level higher than that of the operating threshold. For example, this higher OCV level can be an upper limit set in the power supply as a result of its design or manufacture. It is noted that in some exemplary embodiments, after the wire makes contact with the puddle (at point D) the output of the power supply 170 is shut off for a period of time to allow the wire to engage with the puddle. In some embodiments, this power off delay allows the wire to repenetrate the puddle such that when the heating current is re-added the wire will not lose contact with the puddle. In some exemplary embodiments the time delay is preset within the power supply.

FIG. 11B is similar to that described above, except that the filler wire 140 is contacting the weld puddle when the output of the power supply is increased. In such a situation either the wire never left the weld puddle or the wire was contacted with the weld puddle prior to point C. FIG. 11B shows points C and D together because the wire is in contact with the puddle when the output is turned back on. Thus both the current and voltage increase to the desired operational setting at point E.

FIG. 11C is an embodiment where there is little or no delay between the output being turned off (point A) and being turned back on (point B), and the wire is in contact with the puddle some time prior to point B. The depicted waveforms can be utilized in embodiments described above where a lower threshold is set such that when the lower threshold is reached—whether it's current, power, or voltage—the output is turned back on with little or no delay. It is noted that this lower threshold setting can be set using the same or similar parameters as the operational upper thresholds or ranges as described herein. For example, this lower threshold can be set based on wire composition, diameter, feed speed, or various other parameters described herein. Such an embodiment can minimize delay in returning to the desired operational set points for welding and can minimize any necking that may occur in the wire. The minimization of necking aids in minimizing the chances of an arc being created.

In an exemplary embodiment of the present invention, the sensing and control unit 195 can be coupled to a feed force detection unit (not shown) which is coupled to the wire feeding mechanism (see 150 in FIG. 1). The feed force detection units are known and detect the feed force being applied to the wire 140 as it is being fed to the workpiece 115. For example, such a detection unit can monitor the torque being applied by a wire feeding motor in the wire feeder 150. If the wire 140 passes through the molten weld puddle without fully melting it will contact a solid portion of the workpiece and such contact will cause the feed force to increase as the motor is trying to maintain a set feed rate. This increase in force/torque can be detected and relayed to the control 195 which utilizes this information to adjust the voltage, current and/or power to the wire 140 to ensure proper melting of the wire 140 in the puddle.

It is noted that in some exemplary embodiments of the present invention, the wire is not constantly fed into the weld puddle, but can be done so intermittently based on a desired weld profile. Specifically, the versatility of various embodiments of the present invention allows either an operator or the control unit 195 to start and stop feeding the wire 140 into the puddle as desired. For example, there are many different types of complex weld profiles and geometry that may have some portions of the weld joint which require the use of a filler metal (the wire 140) and other portions of the same joint or on the same workpiece that do not require the use of filler metal. As such, during a first portion of a weld the control unit 195 can operate only the arc welding operation to cause a traditional arc weld of this first portion of the joint, but when the welding operation reaches a second portion of the welding joint—which requires the use of a filler metal—the controller 195 causes the power supply and 170 and the wire feeder 150 to begin depositing the wire 140 into the weld puddle. Then, as the welding operation reaches the end of the second portion the deposition of the wire 140 can be stopped. This allows for the creation of continuous welds having a profile which significantly varies from one portion to the next. Such capability allows a workpiece to be welded in a single welding operation as opposed to having many discrete welding operations. Of course, many variations can be implemented. For example, a weld can have three or more distinct portions requiring a weld profile with varying shape, depth and filler requirements such that the use of the wire 140 can be different in each weld portion. Furthermore, additional wires can be added or removed as needed as well.

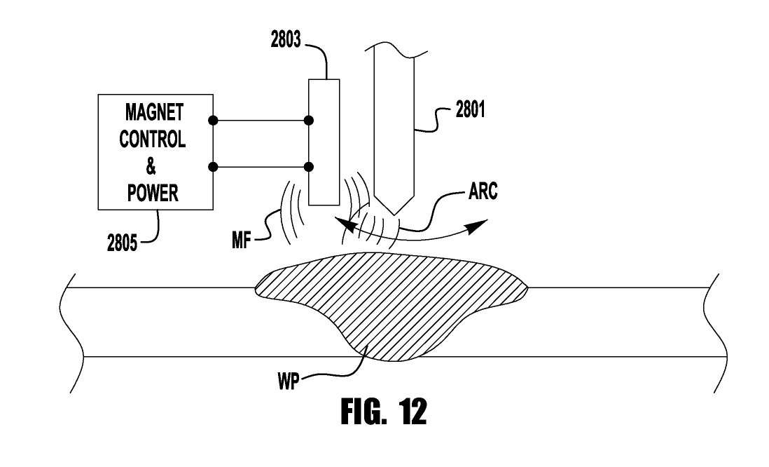

FIG. 12 depicts another exemplary embodiment of the present invention. In this exemplary embodiment, a GTAW electrode 2801 is utilized for the arc welding process and a magnetic probe 2803 is positioned adjacent to the electrode 2801 to control the movement of the arc during welding. Although a GTAW electrode is shown, of course other welding operations can be used, such as GMAW, FCAW, MCAW. The probe 2803 receives a current from the magnetic control and power supply 2805, which may or may not be coupled to the controller 195, and the current causes a magnetic field MF to be generated by the probe 2803. The magnetic field interacts with the magnetic field generated by the arc and can thus be used to move the arc during welding. That is, the arc can be moved from side to side during welding. This side to side movement is used to widen the puddle and aid in wetting out the puddle to achieve the desired weld bead shape. Although not shown for clarity, following the arc is a hot-wire consumable as discussed herein to provide additional filling for the weld bead. The use and implementation of a magnetic steering system is generally known by those in the welding industry and need not be described in detail herein.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A welding system, comprising:
an arc generating power supply which provides an arc generation signal to an electrode to generate an arc between said electrode and at least one workpiece so as to create a molten puddle on said at least one workpiece, where said arc generation signal comprises a plurality of current pulses;
a hot wire power supply which generates a heating signal to heat at least one consumable such that said consumable melts in said molten puddle when said consumable is in contact with said molten puddle, where said heating signal comprises a plurality of heating current pulses; and
a controller which synchronizes both of said arc generation signal and said heating signal such that a constant phase angle is maintained between said current pulses of said arc generation signal and said heating current pulses,
wherein each of said electrode and said consumable are moved in a travel direction relative to said at least one workpiece, and where said electrode is offset from consumable in a direction normal to said travel direction; and
wherein at least one of said hot wire power supply and controller monitors a feedback related to said heating signal and compares said feedback to an arc generation threshold and said hot wire power supply turns off said heating signal when said feedback reaches said arc generation threshold level.

2. The system of claim 1, wherein said phase angle is in the range of 340 to 20 degrees.

3. The system of claim 1, wherein said electrode is offset from said consumable by a distance in the range of 2 to 5 mm.

4. The system of claim 1, wherein a ratio of heat input into said puddle from said arc generation signal to heat input from said heating signal is in the range of 2:1 to 10:1.

5. The system of claim 1, wherein said arc generation signal is a GMAW signal and said electrode is a consumable electrode, and wherein a ratio of heat input into said puddle from said arc generation signal to heat input from said heating signal is at least 3:1, and where a ratio of a deposition rate of said electrode to a deposition rate of said consumable is in the range of 0.85:1 to 1.15:1.

6. The system of claim 1, wherein said arc generation signal is a GMAW signal and said electrode is a consumable electrode, and wherein a ratio of heat input into said puddle from said arc generation signal to heat input from said heating signal is in the range of 3:1 to 7:1, and where a ratio of a deposition rate of said electrode to a deposition rate of said consumable is in the range of 0.85:1 to 1.15:1.

7. The system of claim 1, wherein said at least one workpiece is coated.

8. The system of claim 1, wherein said heating signal has an average running voltage in the range of 2 to 10 volts.

9. The system of claim 1, wherein said arc generation threshold is a voltage in the range of 12 to 19 volts.

10. The system of claim 1, wherein said heating signal has an average running power in the range of 300 to 2,500 watts.

11. A system, comprising:
an arc generating power supply which provides an arc generation signal to an electrode to generate an arc between said electrode and at least one workpiece so as to create a molten puddle on said at least one workpiece, where said arc generation signal comprises a plurality of current pulses;
a hot wire power supply which generates a heating signal to heat at least one consumable such that said consumable melts in said molten puddle when said consumable is in contact with said molten puddle, where said heating signal comprises a plurality of heating current pulses; and
a controller which synchronizes both of said arc generation signal and said heating signal such that a constant phase angle is maintained between said current pulses of said arc generation signal and said heating current pulses,
wherein each of said electrode and said consumable are moved in a travel direction relative to said at least one workpiece, and where said electrode is offset from consumable in a direction normal to said travel direction by a distance in the range of 2 to 5 mm;
wherein at least one of said hot wire power supply and controller monitors a feedback related to said heating signal and compares said feedback to an arc generation threshold and said hot wire power supply turns off said heating signal when said feedback reaches said arc generation threshold level; and
wherein a ratio of heat input into said puddle from said arc generation signal to heat input from said heating signal is at least 2:1.

12. The system of claim 11, wherein said phase angle is in the range of 340 to 20 degrees.

13. The system of claim 11, wherein a ratio of heat input into said puddle from said arc generation signal to heat input from said heating signal is at least 3:1.

14. The system of claim 11, wherein said arc generation signal is a GMAW signal and said electrode is a consumable electrode, and wherein a ratio of heat input into said puddle from said arc generation signal to heat input from said heating signal is at least 3:1, and where a ratio of a deposition rate of said electrode to a deposition rate of said consumable is in the range of 0.85:1 to 1.15:1.

15. The system of claim 11, wherein said arc generation signal is a GMAW signal and said electrode is a consumable electrode, and wherein a ratio of heat input into said puddle from said arc generation signal to heat input from said heating signal is in the range of 3:1 to 7:1, and where a ratio of a deposition rate of said electrode to a deposition rate of said consumable is in the range of 0.85:1 to 1.15:1.

16. The system of claim 11, wherein said at least one workpiece is coated.

17. The system of claim 11, wherein said heating signal has an average running voltage in the range of 2 to 10 volts.

18. The system of claim 11, wherein said arc generation threshold is a voltage in the range of 12 to 19 volts.

19. The system of claim 11, wherein said heating signal has an average running power in the range of 300 to 2,500 watts.

20. A method, comprising:
generating an arc generation signal and providing said arc generation signal to an electrode to generate an arc between said electrode and at least one workpiece so as to create a molten puddle on said at least one workpiece, where said arc generation signal comprises a plurality of current pulses;
generating a heating signal to heat at least one consumable such that said consumable melts in said molten puddle when said consumable is in contact with said molten puddle, where said heating signal comprises a plurality of heating current pulses;
synchronizing both of said arc generation signal and said heating signal such that a constant phase angle is maintained between said current pulses of said arc generation signal and said heating current pulses;
moving each of said consumable and said electrode in a travel direction relative to said at least one workpiece;
offsetting said electrode from said consumable in a direction normal to said travel direction and
monitoring a feedback signal related to said heating signal and comparing said feedback to an arc generation threshold and turning off said heating signal when said feedback reaches said arc generation threshold level.

21. The method of claim 20, wherein said phase angle is in the range of 340 to 20 degrees.

22. The method of claim 20, wherein said electrode is offset from said consumable by a distance in the range of 2 to 5 mm.

23. The method of claim 20, wherein a ratio of heat input into said puddle from said arc generation signal to heat input from said heating signal is in the range of 2:1 to 10:1.

24. The method of claim 20, wherein said arc generation signal is a GMAW signal and said electrode is a consumable electrode, and wherein a ratio of heat input into said puddle from said arc generation signal to heat input from said heating signal is at least 3:1, and where a ratio of a deposition rate of said electrode to a deposition rate of said consumable is in the range of 0.85:1 to 1.15:1.

25. The method of claim 20, wherein said arc generation signal is a GMAW signal and said electrode is a consumable electrode, and wherein a ratio of heat input into said puddle from said arc generation signal to heat input from said heating signal is in the range of 3:1 to 7:1, and where a ratio of a deposition rate of said electrode to a deposition rate of said consumable is in the range of 0.85:1 to 1.15:1.

26. The method of claim 20, wherein said at least one workpiece is coated.

27. The method of claim 20, wherein said heating signal has an average running voltage in the range of 2 to 10 volts.

28. The method of claim 20, wherein said arc generation threshold is a voltage in the range of 12 to 19 volts.

29. The method of claim 20, wherein said heating signal has an average running power in the range of 300 to 2,500 watts.
